(19) United States
(12) Patent Application Publication
(10) Pub. No.: US 2026/0310961 A1
(43) Pub. Date: Oct. 8, 2026

(54) APPARATUS AND METHOD FOR POSITION ESTIMATION BASED ON DISTANCE-BASED CHANNEL CHARTING WITH VELOCITY AND MAP INFORMATION

(71) Applicant: FRAUNHOFER-GESELLSCHAFT ZUR FÖRDERUNG DER ANGEWANDTEN FORSCHUNG E.V., Munchen (DE)

(72) Inventors: Maximilian STAHLKE, Erlangen (DE); George YAMMINE, Erlangen (DE); Christoper MUTSCHLER, Erlangen (DE); Tobias FEIGL, Erlangen (DE); Jochen SEITZ, Erlangen (DE)

(21) Appl. No.: 19/675,930

(22) Filed: May 13, 2026

Related U.S. Application Data
(63) Continuation of application No. PCT/EP2023/081665, filed on Nov. 13, 2023.

(51) Int. Cl. G06N 3/08; G06N 3/045; H04B 7/06

(52) U.S. Cl. CPC G06N 3/08; G06N 3/045; H04B 7/0626

(57) ABSTRACT

A method according to an embodiment is provided. The method includes receiving from at least one device information on a movement of the at least one device, and receiving from at least one device channel state information obtained by the at least one device at a plurality of positions. Moreover, the method includes determining from the movement information distance information indicating a plurality of distances, wherein each of the plurality of distances indicates a distance between two of the plurality of positions, where the at least one device has obtained the channel state information. Furthermore, the method includes training an artificial intelligence system using the channel state information obtained at the plurality of positions and using the distance information, so that the artificial intelligence system returns a position value as output of the artificial intelligence system when receiving channel state information as input of the artificial intelligence system.

### CROSS-REFERENCE TO RELATED APPLICATION

This application is a continuation of International Patent Application No. PCT/EP2023/081665, which was filed on Nov. 13, 2023, and is incorporated herein in its entirety by reference.

The present invention relates to position estimation, to position estimation based on distance-based channel charting and, in particular, to an apparatus and a method for position estimation based on distance-based channel charting with velocity and map information.

### BACKGROUND OF THE INVENTION

Indoor positioning serves as a key enabler for various downstream tasks in industrial production, health care or networking (see [1]). Radio based localization methods (see [2]) are beside, other technologies like camera (see [3]), lidar (see [4]) or visible light based approaches (see [5]), one of the most promising technologies for indoor localization (see [2]). If there are line-of-sight (LoS) conditions, angle of arrival (AoA) (see [6], [7]) or time of arrival (ToA) (see [8]) can achieve high localization accuracies in the centimeter range. However, realistic indoor environments are often cluttered with non-line-of-sight (NLoS) and multipath, which leads to a degradation of the positioning accuracy. To anyway provide robust localization in such environments, error mitigation methods like NLOS identification (see [9]) or error correction (see [10]) can be implemented given a high number of access points. However, if there are limited resources, fingerprint-based methods enable positioning also in NLoS-dominated areas (see [11]-[18]). Fingerprint based localization improves the positioning performance in challenging, non-line-of-sight dominated indoor environments. However, training a fingerprinting model requires labeling CSI measurements with a ground reference, which is often very expensive. In particular, fingerprinting models require an expensive life cycle management including recording and labeling of radio signals for the initial training and regularly at environmental changes. Another common problem with fingerprinting is that environmental changes may alter the site-specific fingerprint, necessitating regular updates, which in turn requires again labeled data (see [12], [15]).

To overcome these problems, in particular to overcome the effort for labeling, a new method called channel charting can be employed (see [19]). Channel charting models the radio geometry, i.e., the relative coordinates of recorded radio signals, to enable positioning. Samples, labeled by a ground truth reference system are used by the conventional technology to enable positioning. However, accuracy for channel charting assisted fingerprinting is lower compared to supervised fingerprinting or the recording process underlies strong assumptions about the movement pattern. Additionally, few labeled samples are still required to enable positioning, thus regular data recording and labeling is inevitable.

Channel charting exploits channel state information (CSI) of radio systems to model the underlying manifold, which reflects the geometry of the environment. The most promising approaches explicitly define the manifold, by means of a distance matrix, to model the radio geometry. This can be done either by the CSI data itself (see [20]-[25]) or by physical models of movement, e.g., the distance is direct proportional to time for an agent moving at constant velocity (see [21]). However, compared to supervised fingerprinting, channel-charting-assisted fingerprinting achieves lower accuracies (see [20]) or underlies strong assumption about the movement (see [21]). Furthermore, few labeled samples are required to exploit the channel chart for localization. As a channel charting degrades similar to environmental changes as fingerprinting, a regular manual labeling process is still inevitable.

Channel charting, first introduced by Studer et al (see [19]), is an emerging approach to model the geometry of the radio environment, which support various tasks like UE grouping (see [26]), radio resource management (see [27]), beam forming (see [28]-[30]), pilot assignment (see [31]) or localization (see [20], [21], [36]-[36]). Channel charting consists typically of two stages: (i) First distances, proportional to the physical distance, have to be estimated between channel measurements, which model the manifold of the channel information, and second (ii) the high dimensional channel measurements have to be reduced to a 2D vector to reflect the coordinates of the radio environment.

The distance metrics are mostly based on the free-space path loss of radio signals (see [19]) with extensions to make it insensitive to fast fading effects (see [22]) or grouping of collinear measurements (see [23]). More advanced approaches extract multipath information with Multiple Signal Identification Classification (MUSIC) to cluster multipath components (MPCs) and exploit the path-loss for every MPC (see [24]). To utilize more environmental information, Stahlke et. al. (see [20]) have shown how to exploit MPC information from power delay profiles for time-synchronized single input single output (SISO) radio systems with high bandwidth. To additional exploit phase information, Stephan et. al (see [21]) have extended this metric for multiple-input/multiple-output (MIMO) radio systems. However, distance estimates based on radio signals are often very noise due to constraints like collinearity and bandwidth limitations, thus recent approaches tried to model the proximity of channel measurements by time. (see [34] and [37]-[39]). They assume that measurements close in time are also close in space and vice versa. However, this only holds in very specific movement pattern like moving cars, but not for e.g., pedestrians in indoor environments (see [20]). However, if specific movement pattern are enforced by walking on straight lines as shown in [25], or even more strict with a constant velocity (see [21]) the quality of the channel charts increase dramatically.

As the idea of channel charting is to model the 2D manifold given the high dimensional channel measurements, a dimensionality reduction has to performed. There are non-parametric approaches like principal component analysis (PCA) (see [19]), Laplacian eigenmaps (see [40] or [22]). However, they are mostly restricted in their ability to model non-linearities or efficiently perform predictions on unseen data. Thus, parametric, neural-network-based, approaches are the most employed type of algorithm like auto-encoders (see [41], [42]). Siamese networks (see [20], [21] or [33]) or triplet-based models (see [25], [34], [37], [38] and [43]). In contrast to their non-parametric counterparts, they can efficiently estimate unseen data and model sufficiently high nonlinearities to model the manifold of the channel measurements.

Channel charting can only model the radio environment up to isometries, thus a transformation is needed to exploit it for localization. this can be done in a semi-supervised way for the coordinate transformation and to restore the geometry of the channel chart due to noisy distance metrics (see [33]-[36]). If the quality of the channel chart is high, a simple linear transformation is already sufficient, which requires only very few ground truth samples (see [20], [21]). However, as fingerprint based models, like channel charting, need regular updates due to environmental changes (see [12]), the effort for regularly recording of only few labeled samples is still demanding. To entirely avoid labeled data samples, Ghazvinian et. al (see [39]) have shown how to exploit map information to perform an alignment of the channel charting coordinates into the environment. Their idea is to define a map as discrete probability density function (PDF), which represents the distribution of the recorded data. The transformation into the real world coordinates is managed by matching the data distribution of the channel chart with the defined map by optimal transport. However, they have a strong assumption that the spatial distribution of the channel chart matches the distribution of the map, which can only be achieved if the data recording is explicitly planned and cannot be covered by crowd sourcing.

Therefore, it would be highly appreciated if improved concepts for position estimation, channel charting and position estimation based on channel charting would be provided.

The object of the present invention is to provide improved concepts for position estimation, channel charting, and for position estimation based on channel charting.

### SUMMARY

According to an embodiment, a method may have the steps of receiving from at least one device information on a movement of the at least one device, and receiving from at least one device channel state information acquired by the at least one device at a plurality of positions, determining from the movement information distance information indicating a plurality of distances, wherein each of the plurality of distances indicates a distance between two of the plurality of positions, where the at least one device has acquired the channel state information, and training an artificial intelligence system using the channel state information acquired at the plurality of positions and using the distance information, so that the artificial intelligence system returns a position value as output of the artificial intelligence system when receiving channel state information as input of the artificial intelligence system.

According to another embodiment, a method may have the steps of training an artificial intelligence system using channel state information acquired at a plurality of positions by at least one device, and using distances between the plurality of positions, so that the artificial intelligence system returns a position value as output of the artificial intelligence system when receiving channel state information as input of the artificial intelligence system, and optimizing a transformation rule, which transforms a position value, which is output by the artificial intelligence system, the position value being represented in a first coordinate system, from the first coordinate system to a second coordinate system, wherein optimizing the transformation rule is conducted using information on an area within the second coordinate system that is not accessible for the at least one device and/or using information on an area within the second coordinate system where the at least one device cannot be located, and/or using information on location probabilities of that the at least one device.

According to another embodiment, an apparatus may have an artificial intelligence system, wherein the artificial intelligence system has been trained with training data by conducting: to generate the training data, receiving, from at least one device, information on a movement of the at least one device, and receiving from at least one device channel state information acquired by the at least one device at a plurality of positions, to generate the training data, determining from the movement information distance information indicating a plurality of distances, wherein each of the plurality of distances indicates a distance between two of the plurality of positions, where the at least one device has acquired the channel state information, and training the artificial intelligence system with the training data by using the channel state information acquired at the plurality of positions and by using the distance information, so that the artificial intelligence system returns a position value as output of the artificial intelligence system when receiving channel state information as input of the artificial intelligence system.

According to another embodiment, an apparatus may have an artificial intelligence system, wherein the artificial intelligence system has been trained using channel state information acquired at a plurality of positions by at least one device, and using distances between the plurality of positions, so that the artificial intelligence system returns a position value as output of the artificial intelligence system when receiving channel state information as input of the artificial intelligence system, and wherein the apparatus further comprises a transform unit implementing a transformation rule for transforming a position value, which is output by the artificial intelligence system, the position value being represented in a first coordinate system, from the first coordinate system to a second coordinate system, wherein the transformation rule has been optimized using information on an area within the second coordinate system that is not accessible for the at least one device and/or an area within the second coordinate system where the at least one device cannot be located and/or using information on location probabilities of that the at least one device.

According to another embodiment, a method for employing an apparatus having an artificial intelligence system may have the steps of: providing channel state information as input of the artificial intelligence system, and receiving a position value as input of the artificial intelligence system, wherein the artificial intelligence system has been trained with training data by conducting: to generate the training data, receiving, from at least one device, information on a movement of the at least one device, and receiving from at least one device channel state information acquired by the at least one device at a plurality of positions, to generate the training data, determining from the movement information distance information indicating a plurality of distances, wherein each of the plurality of distances indicates a distance between two of the plurality of positions, where the at least one device has acquired the channel state information, and training the artificial intelligence system with the training data by using the channel state information acquired at the plurality of positions and by using the distance information, so that the artificial intelligence system returns a position value as output of the artificial intelligence system when receiving channel state information as input of the artificial intelligence system.

According to another embodiment, a method for employing an apparatus having an artificial intelligence system and a transform unit may have the steps of: providing channel state information as input of the artificial intelligence system, receiving a position value as input of the artificial intelligence system, and transforming, by the transform unit, the position value, which is represented in a first coordinate system, from the first coordinate system to a second coordinate system, using a transformation rule, wherein the artificial intelligence system has been trained using channel state information acquired at a plurality of positions by at least one device, and using distances between the plurality of positions, so that the artificial intelligence system returns a position value as output of the artificial intelligence system when receiving channel state information as input of the artificial intelligence system, and wherein the transformation rule is a rule for transforming a position value, which is output by the artificial intelligence system, the position value being represented in the first coordinate system, from the first coordinate system to the second coordinate system, wherein the transformation rule has been optimized using information on an area within the second coordinate system that is not accessible for the at least one device and/or an area within the second coordinate system where the at least one device cannot be located and/or using information on location probabilities of that the at least one device.

According to another embodiment, a non-transitory digital storage medium may have a computer program stored thereon to perform the methods of the invention when said computer program is run by a computer.

A method according to an embodiment is provided. The method comprises receiving from at least one device information on a movement of the at least one device, and receiving from at least one device channel state information obtained by the at least one device at a plurality of positions. Moreover, the method comprises determining from the movement information distance information indicating a plurality of distances, wherein each of the plurality of distances indicates a distance between two of the plurality of positions, where the at least one device has obtained the channel state information. Furthermore, the method comprises training an artificial intelligence system using the channel state information obtained at the plurality of positions and using the distance information, so that the artificial intelligence system returns a position value as output of the artificial intelligence system when receiving channel state information as input of the artificial intelligence system.

Moreover, a method according to another embodiment is provided. The method comprises training an artificial intelligence system using channel state information obtained at a plurality of positions by at least one device, and using distances between the plurality of positions, so that the artificial intelligence system returns a position value as output of the artificial intelligence system when receiving channel state information as input of the artificial intelligence system. Moreover, the method comprises optimizing a transformation rule, which transforms a position value, which is output by the artificial intelligence system, the position value being represented in a first coordinate system, from the first coordinate system to a second coordinate system. Optimizing the transformation rule is conducted using information on an area within the second coordinate system that is not accessible for the at least one device and/or using information on an area within the second coordinate system where the at least one device cannot be located, and/or using information on location probabilities of that the at least one device.

Furthermore, an apparatus comprising an artificial intelligence system according to an embodiment is provided. The artificial intelligence system has been trained with training data by conducting the following steps: To generate the training data, receiving, from at least one device, information on a movement of the at least one device, and receiving from at least one device channel state information obtained by the at least one device at a plurality of positions. To generate the training data, determining from the movement information distance information indicating a plurality of distances, wherein each of the plurality of distances indicates a distance between two of the plurality of positions, where the at least one device has obtained the channel state information. And, training the artificial intelligence system with the training data by using the channel state information obtained at the plurality of positions and by using the distance information, so that the artificial intelligence system returns a position value as output of the artificial intelligence system when receiving channel state information as input of the artificial intelligence system.

Moreover, an apparatus comprising an artificial intelligence system according to an embodiment is provided. The artificial intelligence system has been trained using channel state information obtained at a plurality of positions by at least one device, and using distances between the plurality of positions, so that the artificial intelligence system returns a position value as output of the artificial intelligence system when receiving channel state information as input of the artificial intelligence system. The apparatus further comprises a transform unit implementing a transformation rule for transforming a position value, which is output by the artificial intelligence system, the position value being represented in a first coordinate system, from the first coordinate system to a second coordinate system. The transformation rule has been optimized using information on an area within the second coordinate system that is not accessible for the at least one device and/or an area within the second coordinate system where the at least one device cannot be located and/or using information on location probabilities of that the at least one device.

Furthermore, a method for employing an apparatus comprising an artificial intelligence system according to an embodiment is provided. The method comprises:
Providing channel state information as input of the artificial intelligence system. And:
Receiving a position value as input of the artificial intelligence system.

The artificial intelligence system has been trained with training data by conducting the following steps: To generate the training data, receiving, from at least one device, information on a movement of the at least one device, and receiving from at least one device channel state information obtained by the at least one device at a plurality of positions. To generate the training data, determining from the movement information distance information indicating a plurality of distances, wherein each of the plurality of distances indicates a distance between two of the plurality of positions, where the at least one device has obtained the channel state information. And, training the artificial intelligence system with the training data by using the channel state information obtained at the plurality of positions and by using the distance information, so that the artificial intelligence system returns a position value as output of the artificial intelligence system when receiving channel state information as input of the artificial intelligence system.

Moreover, a method for employing an apparatus comprising an artificial intelligence system and a transform unit according to an embodiment has been provided. The method comprises:
Providing channel state information as input of the artificial intelligence system.
Receiving a position value as input of the artificial intelligence system. And:
Transforming, by the transform unit, the position value, which is represented in a first coordinate system, from the first coordinate system to a second coordinate system, using a transformation rule.

The artificial intelligence system has been trained using channel state information obtained at a plurality of positions by at least one device, and using distances between the plurality of positions, so that the artificial intelligence system returns a position value as output of the artificial intelligence system when receiving channel state information as input of the artificial intelligence system. And, the transformation rule is a rule for transforming a position value, which is output by the artificial intelligence system, the position value being represented in the first coordinate system, from the first coordinate system to the second coordinate system. The transformation rule has been optimized using information on an area within the second coordinate system that is not accessible for the at least one device and/or an area within the second coordinate system where the at least one device cannot be located and/or using information on location probabilities of that the at least one device.

Moreover, computer programs are provided, wherein each of the computer programs is configured to implement one of the above-described methods when being executed on a computer or signal processor.

Embodiments contribute a framework to the channel charting concept. to create a fingerprinting model without the need for a ground truth reference system. We propose a way to exploit velocity information estimated by, e.g., a pedestrian dead reckoning or odometry system to generate a channel chart and learn a transformation to the real world coordinates by topological map information like a floor plan. We evaluate our approach on two different real world datasets and radio systems, a 5G, single input single output (SISO) setup, and distributed single input multiple output (SIMO) system. Our evaluations show that we can achieve accuracies similar to supervised fingerprinting, even with noisy velocity estimation and coarse map information due to our adaptive map matching algorithm.

Embodiments inter alia provide the following contributions to address these limitations. It is investigate how to exploit noisy velocity information, e.g., derived from pedestrian dead reckoning (PDR) or odometry systems, to model a channel chart. An evaluation on the impact of various error sources for velocity estimation on the channel charting based localization performance is conducted, and it is shown that an algorithm according to an embodiment is very robust and thus also applicable to low cost velocity estimation systems. Additionally, it is shown that combining different recordings with different trajectories is possible enabling crowd sourced data recording. To overcome the need for a ground truth reference system, it is proposed to exploit topological map information to learn a transformation to the real world coordinates. In contrast to the state of the art, according to embodiments, only a coarse representation of the environment is needed, e.g., a floor plan, as a map matching algorithm according to embodiments learns to adapt the map information simultaneously to the alignment of the channel chart. The algorithm is evaluated on two different radio systems, a 5G based radio system and a distributed SIMO system to show the independence to radio topologies and architectures. The results show that embodiments achieve similar results to supervised fingerprinting, rendering ground truth reference systems irrelevant.

### BRIEF DESCRIPTION OF THE DRAWINGS

Embodiments of the present invention will be detailed subsequently referring to the appended drawings, in which:

FIG. 1 illustrates a method according to an embodiment.

FIG. 2 illustrates a method according to another embodiment.

FIG. 3 illustrates a distance estimation process according to an embodiment, wherein a trajectory of an agent conducting consecutive CSI measurements is depicted.

FIG. 4 illustrates stage 1 of a positioning pipeline according to an embodiment, depicting channel charting of an embodiment.

FIG. 5 illustrates stage 2 of a positioning pipeline according to an embodiment, depicting map matching according to an embodiment.

FIG. 6 illustrates a schematic top view (left) of an environment (right) of a 5G dataset according to an embodiment.

FIG. 7 illustrates a schematic top view of the environment of a SIMO dataset according to an embodiment.

FIG. 8 illustrates a topological map of a 5G dataset (left) and the SIMO dataset (right) according to an embodiment.

FIG. 9 illustrates example trajectories of noise levels 1 to 4 according to an embodiment.

FIG. 10 illustrates trajectories of the training datasets according to an embodiment.

FIG. 11 illustrates the ground truth locations on the left hand side, while the channel chart according to an embodiment is shown on the right hand side.

FIG. 12 illustrates channel charts for a 5G dataset generated with different time windows according to an embodiment, wherein in the top left corner, the ground truth trajectory of the test dataset is shown, and wherein in the other tiles, the channel chart for 5 s (top right), 15 s (bottom left) and 60 s (bottom right) are shown.

FIG. 13 illustrates channel charts for the SIMO dataset according to an embodiment, generated with different time windows, wherein In the top left corner, the ground truth trajectory of the test dataset is shown, and wherein in the other tiles, the channel charts for 15 s (top right), 30 s (bottom left) and 60 s (bottom right) are shown.

FIG. 14 illustrates results of the map matching algorithms for the 5G dataset according to an embodiment, wherein the plot top left shows the least squares approach, top right shows the map matching with a trainable map distribution, bottom left the map matching with a static map and bottom right the combined approach.

FIG. 15 illustrates a distribution of the data of the 5G dataset within the environment on the left, while the learned map according to an embodiment is shown on the right.

FIG. 16 illustrates results of the map matching algorithms for the SIMO dataset, wherein the plot top left shows the least squares approach, top right shows the map matching with a trainable map distribution, bottom left the map matching with a static map and bottom right the combined approach.

FIG. 17 illustrates a distribution of the data of the SIMO dataset within the environment on the left, while the learned map is shown on the right.

### DETAILED DESCRIPTION OF THE INVENTION

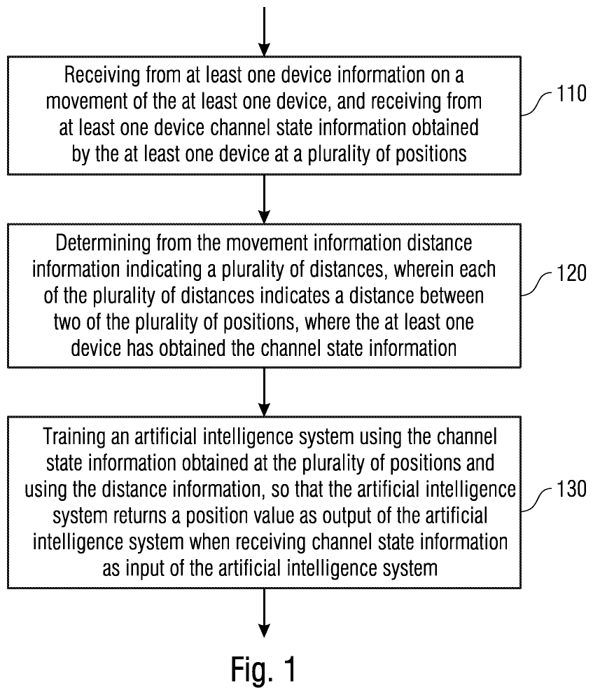

FIG. 1 illustrates a method according to an embodiment. The method comprises:

Receiving from at least one device information on a movement of the at least one device, and receiving from at least one device channel state information obtained by the at least one device at a plurality of positions (110 in FIG. 1).

Determining from the movement information distance information indicating a plurality of distances, wherein each of the plurality of distances indicates a distance between two of the plurality of positions, where the at least one device has obtained the channel state information (120 in FIG. 1). And:

Training an artificial intelligence system using the channel state information obtained at the plurality of positions and using the distance information, so that the artificial intelligence system returns a position value as output of the artificial intelligence system when receiving channel state information as input of the artificial intelligence system (130 in FIG. 1).

According to an embodiment, the artificial intelligence system may, e.g., be trained by inputting the distance information and the channel state information into the artificial intelligence system for the training of the artificial intelligence system, but without inputting the plurality of positions into the artificial intelligence system for the training.

In an embodiment, the artificial intelligence system may, e.g., be trained using a plurality of training data tuples. Each training data tuple of the plurality of training data tuples may, e.g., comprise a distance of the plurality of distances between a first position and a second position of the plurality of positions, first channel state information data that has been obtained at the first position, and second channel state information data that has been obtained at the second position.

For example, the artificial intelligence system may, e.g., be trained with hundreds, thousands or tens of thousands of training data tuples. Each of the training data tuples may comprise: CSI data obtained at a first position, CSI data obtained at a second position and a distance value indicating a distance between the first position and the second position. It is understood that the hundreds, thousands or tens of thousands of training data tuples usually comprise CSI data obtained at various different positions, and that the training data tuples are obtained for different position combinations. For example, consider that CSI data CSI_{P1}, CSI_{P2}, CSI_{P3} that has been obtained at positions P1, P2 and P3, wherein d_{P1,P2}, d_{P1,P3}, d_{P2,P3} are the distances between the positions, respectively. Thus, for example, the following training data tuples may, e.g., be derived:
<CSI_{P1}; CSI_{P2}; d_{P1,P2}>, <CSI_{P1}; CSI_{P3}; d_{P1,P3}>, <CSI_{P2}; CSI_{P3}; d_{P2,P3}>.

According to an embodiment, the artificial intelligence system may, e.g., be trained by minimizing a difference between
a distance of the plurality of distances between a first position and a second position of the plurality of positions, and
a distance between a first position value and a second position value, wherein the first position value is output by the artificial intelligence system, when the artificial intelligent system receives the channel state information obtained at the first position, and wherein the second position value is output by the artificial intelligence system, when the artificial intelligent system receives the channel state information obtained at the second position.

An example for such an embodiment is provided in formula (3) below, where the network may, e.g., minimize the following loss function

$${ℒ}_{d} = \vert {d}_{n , k} - {‖ {z}_{n} - {z}_{k} ‖}_{2} \vert ,$$

wherein zₙ and zₖ are the (e.g., 2D) outputs of the neural network, given the CSI measurements of the radio system.

In an embodiment, the information on the movement of the at least one device may, e.g., comprise information on an acceleration and/or information on a rotation rate, and/or information on a magnetic field, and/or information on a velocity, and/or information on a number of movement steps, and/or information on (e.g., atmospheric) pressure.

According to an embodiment, the information on the movement of the at least one device may, e.g., comprise information on a direction of the movement of the at least one device.

In an embodiment, the movement of the at least one device may, e.g., represent a movement along a first trajectory and represents a movement along a second trajectory, and the at least one device obtains the channel state information when being on the first trajectory and when being on the second trajectory. The at least one device may, e.g., conduct the movement along the first trajectory and along the second trajectory such that the first trajectory and the second trajectory overlap and/or intersect.

According to an embodiment, the at least one device may, e.g., be two or more devices (e.g., a crowd of devices), and the two or more devices may, e.g., move along different trajectories to determine the channel state information.

In an embodiment, determining the distance information may, e.g., be conducted using at least one of the following concepts:
a localization concept which employs time-of-arrival information and/or time-difference-of-arrival information and/or time-of-flight information and/or received signal strength indication (RSSI) information and/or angular information (e.g., angle-of-arrival and/or angle-of-departure information);
a GPS- or UWB- or Bluetooth- or WLAN-based localization concept;
a localization concept based on sidelink ranging.

Or, for example, the distances may, e.g., be estimated using pseudo sidelink ranging based on the channel charting. Regarding pseudo sidelink ranging based on channel charting, if another/an old channel charting model already exist, that channel charting model can be used to determine a distance between two measurements. For example, different radio systems may be operated in parallel, such as WLAN and 5G. For example, the WLAN channel chart may, e.g., be used to determine distances for the 5G. The term “pseudo” relates to that no communication as in typical sidelink ranging is necessary, but instead, the distance is determined using the other/old channel chart.

In some embodiments, information on an estimated distance and on an estimated error of the distance estimation may, e.g., be determined and may, e.g., be taken into account. For example, such an estimated error may, e.g., received from the at least one device.

According to an embodiment, the method may, e.g., comprise determining a quality measure, e.g., a standard deviation, for an estimation of the plurality of distances being determined from the movement information, where the at least one device has obtained the channel state information. Optimizing the artificial intelligence system may, e.g., be conducted using the quality measure.

In an embodiment, artificial intelligence system that is trained may, e.g., be a neural network, e.g., a Siamese neural network.

According to an embodiment, the method may, e.g., further comprise optimizing a transformation rule, which transforms a position value, which is output by the artificial intelligence system, the position value being represented in a first coordinate system, from the first coordinate system to a second coordinate system. Optimizing the transformation rule may, e.g., be conducted using information on an area within the second coordinate system that is not accessible for the at least one device and/or an area within the second coordinate system where the at least one device cannot be located and/or using information on location probabilities of that the at least one device.

For example, the first coordinate system may, e.g., be a two-dimensional coordinate system. Or, for example, the first coordinate system may, e.g., be a three-dimensional coordinate system.

For example, the location probabilities may, e.g., be obtained from a map.

For example, a point cloud may, e.g., be generated which describes the location probabilities at particular points for the at least one device.

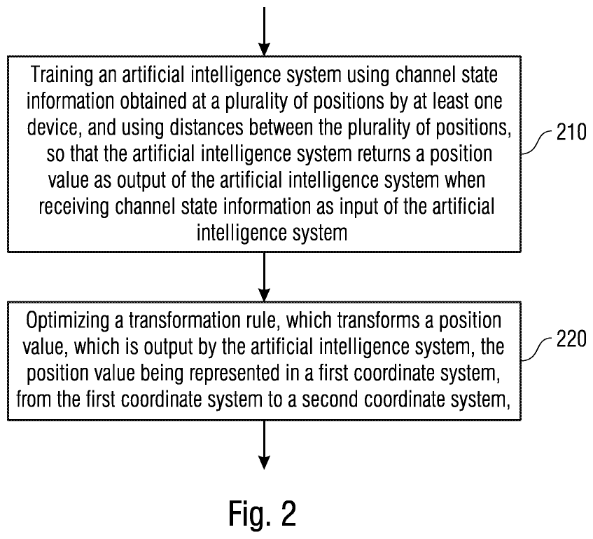

FIG. 2 illustrates a method according to another embodiment. The method comprises:

Training an artificial intelligence system using channel state information obtained at a plurality of positions by at least one device, and using distances between the plurality of positions, so that the artificial intelligence system returns a position value as output of the artificial intelligence system when receiving channel state information as input of the artificial intelligence system (210 in FIG. 2). And:

Optimizing a transformation rule, which transforms a position value, which is output by the artificial intelligence system, the position value being represented in a first coordinate system, from the first coordinate system to a second coordinate system (220 in FIG. 2).

Optimizing the transformation rule is conducted using information on an area within the second coordinate system that is not accessible for the at least one device and/or using information on an area within the second coordinate system where the at least one device cannot be located, and/or using information on location probabilities of that the at least one device.

Again, for example, the first coordinate system may, e.g., be a two-dimensional coordinate system. Or, for example, the first coordinate system may, e.g., be a three-dimensional coordinate system.

In some embodiments, the transformation rule may, e.g., define a linear transformation. In other embodiments, the transformation rule may, e.g., define a non-linear transformation.

According to an embodiment, the information on the area within the second coordinate system that is not accessible for the at least one device and/or the information on the area within the second coordinate system where the at least one device cannot be located, may, e.g., be obtained from a map.

In an embodiment, the second coordinate system may, e.g., be a coordinate system of a map.

According to an embodiment, the transformation rule which transforms the position value being output by the artificial intelligence system from the first coordinate system to the coordinate system of the map, may, e.g., comprise at least one rotation step, and/or at least one translation step, and/or at least one scaling step (e.g., stretching and/or compressing).

For example, scaling may, e.g., be necessary, for example, if a wrong estimation of a step length has been made, or, for example, if a wheel of a robot is flat and/or the convolution of the wheel is (thus) other than normal.

According to an embodiment, optimizing the transformation rule may, e.g., be conducted
taking into account for optimizing if the transformation rule transforms one or more position values obtained from training data from the first coordinate system to coordinate values of the second coordinate system at locations where a map indicates that the at least one device cannot be located, and/or
taking into account for optimizing if the transformation rule transforms one or more position values obtained from training data from the first coordinate system to coordinate values of the second coordinate system at locations where the map indicates that it is possible that the at least one device may possibly be located.

In an embodiment, the method may, e.g., comprise employing one or more reference coordinates for optimizing the transformation rule.

Furthermore, an apparatus comprising an artificial intelligence system according to an embodiment is provided.

The artificial intelligence system has been trained with training data by conducting the following steps:

To generate the training data, receiving, from at least one device, information on a movement of the at least one device, and receiving from at least one device channel state information obtained by the at least one device at a plurality of positions.

To generate the training data, determining from the movement information distance information indicating a plurality of distances, wherein each of the plurality of distances indicates a distance between two of the plurality of positions, where the at least one device has obtained the channel state information. And:

Training the artificial intelligence system with the training data by using the channel state information obtained at the plurality of positions and by using the distance information, so that the artificial intelligence system returns a position value as output of the artificial intelligence system when receiving channel state information as input of the artificial intelligence system.

According to an embodiment, the artificial intelligence system may have been trained by inputting the distance information and the channel state information into the artificial intelligence system for the training of the artificial intelligence system, but without inputting the plurality of positions into the artificial intelligence system for the training.

According to an embodiment, the artificial intelligence system may have been trained using the training data comprising a plurality of training data tuples. Each training data tuple of the plurality of training data tuples may, e.g., comprise a distance of the plurality of distances between a first position and a second position of the plurality of positions, first channel state information data that has been obtained at the first position, and second channel state information data that has been obtained at the second position.

In an embodiment, the artificial intelligence system may have been trained by minimizing a difference between
a distance of the plurality of distances between a first position and a second position of the plurality of positions, and
a distance between a first position value and a second position value, wherein the first position value is output by the artificial intelligence system, when the artificial intelligent system receives the channel state information obtained at the first position, and wherein the second position value is output by the artificial intelligence system, when the artificial intelligent system receives the channel state information obtained at the second position.

According to an embodiment, the information on the movement of the at least one device may, e.g., comprise information on an acceleration and/or information on a rotation rate, and/or information on a magnetic field, and/or information on a velocity, and/or information on a number of movement steps, and/or information on (e.g., atmospheric) pressure.

In an embodiment, the information on the movement of the at least one device may, e.g., comprise information on a direction of the movement of the at least one device.

According to an embodiment, the movement of the at least one device may, e.g., represent a movement along a first trajectory and represents a movement along a second trajectory, and the at least one device obtains the channel state information when being on the first trajectory and when being on the second trajectory. To generate the training data, the at least one device may, e.g., have conducted the movement along the first trajectory and along the second trajectory such that the first trajectory and the second trajectory overlap and/or intersect.

In an embodiment, the at least one device may, e.g., be two or more devices (e.g., a crowd of devices), and the two or more devices may, e.g., have moved along different trajectories to determine the channel state information.

According to an embodiment, to generate the training data, the distance information may have been determined using at least one of the following concepts:
a localization concept which employs time-of-arrival information and/or time-difference-of-arrival information and/or time-of-flight information and/or received signal strength indication (RSSI) information and/or angular information (e.g., angle-of-arrival and/or angle-of-departure information);
a GPS- or UWB- or Bluetooth- or WLAN-based localization concept;
a localization concept based on sidelink ranging.

In an embodiment, to generate the training data, a quality measure, e.g., a standard deviation, for an estimation of the plurality of distances being determined from the movement information, where the at least one device has obtained the channel state information, may have been determined. Optimizing the artificial intelligence system may have been conducted using the quality measure.

According to an embodiment, artificial intelligence system may, e.g., be a neural network, e.g., a Siamese neural network.

In an embodiment, the apparatus may, e.g., further comprise a transform unit implementing a transformation rule for transforming a position value, which is output by the artificial intelligence system, the position value being represented in a first coordinate system, from the first coordinate system to a second coordinate system. The transformation rule may have been optimized using information on an area within the second coordinate system that is not accessible for the at least one device and/or an area within the second coordinate system where the at least one device cannot be located and/or using information on location probabilities of that the at least one device.

Moreover, an apparatus comprising an artificial intelligence system according to an embodiment is provided.

The artificial intelligence system has been trained using channel state information obtained at a plurality of positions by at least one device, and using distances between the plurality of positions, so that the artificial intelligence system returns a position value as output of the artificial intelligence system when receiving channel state information as input of the artificial intelligence system.

The apparatus further comprises a transform unit implementing a transformation rule for transforming a position value, which is output by the artificial intelligence system, the position value being represented in a first coordinate system, from the first coordinate system to a second coordinate system.

The transformation rule has been optimized using information on an area within the second coordinate system that is not accessible for the at least one device and/or an area within the second coordinate system where the at least one device cannot be located and/or using information on location probabilities of that the at least one device.

According to an embodiment, the information on the area within the second coordinate system that is not accessible for the at least one device and/or the information on the area within the second coordinate system where the at least one device cannot be located, may have been obtained from a map.

In an embodiment, the second coordinate system may, e.g., be a coordinate system of a map.

According to an embodiment, the transformation rule which transforms the position value being output by the artificial intelligence system from the first coordinate system to the coordinate system of the map, may, e.g., comprise at least one rotation step, and/or at least one translation step, and/or at least one scaling step (e.g., stretching and/or compressing).

According to an embodiment, optimizing the transformation rule may, e.g., be conducted
taking into account for optimizing if the transformation rule transforms one or more position values obtained from training data from the first coordinate system to coordinate values of the second coordinate system at locations where a map indicates that the at least one device cannot be located, and/or
taking into account for optimizing if the transformation rule transforms one or more position values obtained from training data from the first coordinate system to coordinate values of the second coordinate system at locations where the map indicates that it is possible that the at least one device may possibly be located.

In an embodiment, the transformation rule may have been optimized by employing one or more reference coordinates.

Furthermore, a method for employing an apparatus comprising an artificial intelligence system according to an embodiment is provided. The method comprises:
Providing channel state information as input of the artificial intelligence system. And:
Receiving a position value as input of the artificial intelligence system.

The artificial intelligence system has been trained with training data by conducting the following steps:

To generate the training data, receiving, from at least one device, information on a movement of the at least one device, and receiving from at least one device channel state information obtained by the at least one device at a plurality of positions.

To generate the training data, determining from the movement information distance information indicating a plurality of distances, wherein each of the plurality of distances indicates a distance between two of the plurality of positions, where the at least one device has obtained the channel state information.

And, training the artificial intelligence system with the training data by using the channel state information obtained at the plurality of positions and by using the distance information, so that the artificial intelligence system returns a position value as output of the artificial intelligence system when receiving channel state information as input of the artificial intelligence system.

Moreover, a method for employing an apparatus comprising an artificial intelligence system and a transform unit according to an embodiment has been provided. The method comprises:
Providing channel state information as input of the artificial intelligence system.
Receiving a position value as input of the artificial intelligence system. And:
Transforming, by the transform unit, the position value, which is represented in a first coordinate system, from the first coordinate system to a second coordinate system, using a transformation rule.

The artificial intelligence system has been trained using channel state information obtained at a plurality of positions by at least one device, and using distances between the plurality of positions, so that the artificial intelligence system returns a position value as output of the artificial intelligence system when receiving channel state information as input of the artificial intelligence system.

And, the transformation rule is a rule for transforming a position value, which is output by the artificial intelligence system, the position value being represented in the first coordinate system, from the first coordinate system to the second coordinate system.

The transformation rule has been optimized using information on an area within the second coordinate system that is not accessible for the at least one device and/or an area within the second coordinate system where the at least one device cannot be located and/or using information on location probabilities of that the at least one device.

In the following, particular embodiments are described.

At first, it is described, how, according to particular embodiments, velocity data may, e.g., be employed to generate a channel chart, and it is described how to conduct a transformation from the local channel charting coordinates (e.g., of a first coordinate system) into the real world coordinates (e.g., of a second coordinate system) by using coarse map information.

At first, velocity-based channel charting according to embodiments is described.

Channel charting typically employs a distance matrix, which defines the manifold of the data, to obtain the chart of the radio environment. According to some embodiments, a sparse distance matrix is generated based on velocity information available during data recording to estimate local distances between channel measurements.

Velocity information may, e.g., be obtained by many devices, especially in indoor environments like car production lines or storage centers. Robot platform or industrial cars like fork lifts often have odometry systems available like wheel based odometry (see [44]) or visual odometry (see [45]). Also, many devices carried by persons, like smartphones, include inertial measurement units, which can be used to estimate velocity information by PDR algorithms (see [46]). In theory, if the velocity information contains no errors it can be used to obtain positions for a fingerprinting system by means of integration over time. However, odometry or PDR systems are often error prone due to slipping wheels, varying tire pressure, wrong step length estimation or drifting IMU sensors. This leads to large localization errors due to the integration over time. Hence, velocity estimation systems are mostly used to assist positioning systems in short term and are not suitable for stand-alone localization. However, for short periods the relative positions can be very accurate and can therefore be used to estimate distances between consecutive measurements for a certain time window. In some embodiments, this ability may, e.g., be employed to create a sparse distance matrix, which is then used for channel charting by a Siamese network.

Some embodiments may, e.g., employ a sparse distance matrix: While an agent moves along a trajectory in a certain environment, CSI of a radio system may, e.g., be recorded regularly along with the velocity. Within a certain window w, distances between the consecutive CSI can be calculated by means of integration of the velocity over time.

The distances within a window may, e.g., be defined as

$$\begin{matrix}{d}_{n , k} & = & {‖ {p}_{n} - {p}_{k} ‖}_{2} & ( 1 ) \\ & = & {‖ {\int }_{t = {t}_{n}}^{{t}_{k}} v ( t ) dt ‖}_{2} , & ( 2 )\end{matrix}$$

where tₙ and tₖ are the time of the first measurement and a later measurement within the window. d_{n,k} is the euclidean distance between the positions Pₙ and Pₖ estimated by the velocity v(t). As the estimated trajectory drift over time, we constrain the distance estimation so that tₖ−tₙ<w, while all distances from the first measurement at Pₙ to all consecutive measurements until the end of the window may, e.g., be calculated.

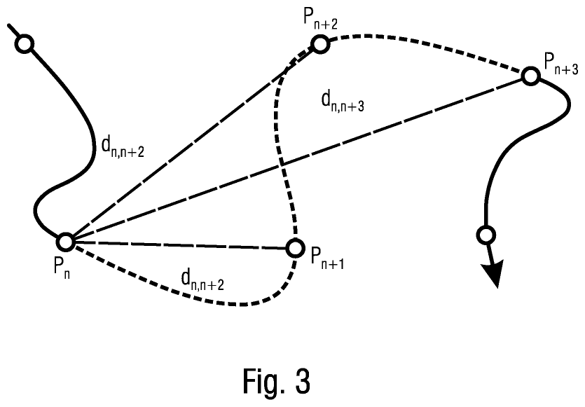

FIG. 3 visualizes the distance estimation process. In particular, FIG. 3 illustrates a trajectory of an agent (gray) with consecutive CSI measurements (red dots). The distances d_{n, n+1}, . . . , d_{n, n+3} are calculated within a window (green) for the positions Pₙ, . . . , Pₙ₊₃.

An agent, e.g., equipped with a PDR or odometry, moves along a trajectory (gray) within the radio environment and regularly records channel measurements (red). Within a certain time window (green) the distances between, the position Pₙ and the consecutive positions Pₙ₊₁, . . . , Pₙ₊₃, estimated by the velocity, are calculated. Then the window is moved by one or more positions, dependent on the stride length s, and the next distances are calculated until the end of the trajectory. This leads to a sparse distance matrix, as only the distances within the windows are calculated.

Now, channel charting according to embodiments is described.

Channel charting exploits the CSI and distance matrix to unroll the high dimensional CSI of radio signals into a 2D space reflecting the coordinates of the radio environment. There are approaches, which solely use the distance matrix for dimensionality reduction like multidimensional scaling (see [47]) or Sammon's mapping (see [48]). However, their requirement is that the distance matrix fully describes the manifold. However, we only have a sparse distance matrix along a trajectory. Further, according to embodiments, it is intended to combine data from different trajectories, which are not interconnected rendering the problem even harder.

Recently neural networks, like triplet based approaches (see [34], [37], [38]) or Siamese networks (see [20], [21], [33]) have been employed to model the channel chart as they enable to efficiently perform inference on unseen data points as they learn a mapping from the CSI to 2D coordinates. Beside the advantage on inference, they also have shown to learn the manifold of the underlying CSI data on a sparse distance matrix.

According to embodiments, therefore a Siamese network may, e.g., be employed to model the manifold of CSI data. A Siamese network is a neural network, which minimizes high dimensional input data, here, in embodiments, the CSI of a radio system, to a low dimensional tensor, in a particular embodiment, to 2D coordinates. (In another embodiment, e.g., to 3D coordinates).

The network may, e.g., minimize the distance relation (1) by using the following loss function:

$${ℒ}_{d} = \vert {d}_{n , k} - {‖ {z}_{n} - {z}_{k} ‖}_{2} \vert , \qquad ( 3 )$$

while zₙ and zₖ are the 2D outputs of the neural network, given the CSI measurements of the radio system. For Siamese networks of embodiments, similar architectures may, e.g., be employed as proposed in [20]. The network may, e.g., consist of four convolutional layers for feature extraction, followed by two dense for discrimination. According to an embodiment, batch normalization for the convolutional layers followed by rectified linear unit (ReLU) activation functions may, e.g., be used to introduce non-linearities. For the last layer no activation function is used. Between the convolutional layers, no local pooling operations may, e.g., be used, as keeping the dimension of time has shown good results in time series downstream tasks (see [49]). To anyway reduce the dimensionality, global average pooling right after the last convolutional layer may, e.g., be employed. To enhance the receptive field of the convolutional layers with depth, the kernel sizes of the layers may, e.g., be increased. As CSI from different radio systems may, e.g., be used, the architectures may, e.g., be adapted to each radio system. Particular parameters of the networks of particular examples are summarized in Table 1, which depicts parameters of Siamese network architectures for 5G and for SIMO radio setups.

TABLE 1

| | Channels | | Kernel size | | |
|---|---|---|---|---|---|
| Layer type | 5G | SIMO | 5G | SIMO | Activation |
| Conv. | 8 | 8 | 3 | 3 | ReLU |
| Conv. | 8 | 8 | 5 | 5 | ReLU |
| Conv. | 8 | 8 | 7 | 7 | ReLU |
| Conv. | 8 | 8 | 10 | 10 | ReLU |
| Avg. Pool. | 8 × 49 | 32 × 100 | — | — | — |
| Fully Con. | 200 | 200 | — | — | ReLU |
| Fully Con. | 2 | 2 | — | — | — |

Now, adaptive map matching according to embodiments is described.

Channel charting can only model the model up to isometries. Hence, to use channel charting for localization, a transformation from the local channel charting coordinate system to the real world coordinate frame is required. There are semi-supervised approaches, which integrate ground truth reference points into their optimization process (see [33]-[36]). However, if the quality of the channel chart is high, a simple linear transformation, requiring only very few ground truth samples, is already sufficient to achieve high localization accuracies (see [20], [21]). Nevertheless, ground truth reference points are still employed in the conventional technology to enable localization. To overcome the need for ground truth positions, Ghazvinian et al. (see [39]) proposed to use map information of the environment to perform a transformation to the real world environment.

With respect to optimal transport, their idea is to derive a discrete probability density function from a topological map information, e.g., a floor plan, and match the channel charting coordinates to this distribution by optimal transport. They estimate a transportation matrix

$$T ∈ {ℝ}_{+}^{s \times t} ,$$

which satisfies

$$Λ ( C , p , q ) = {arg min}_{T ∈ γ ( p , q )} 〈 T , C 〉 - \frac{1}{λ} H ( T ) \qquad ( 4 )$$

where [symbol] , [symbol] is the Frobenius inner product, p and q are probability distributions of samples from the source domain Ωₛ, in embodiments, the distribution of the channel chart, and the target domain Ωₜ, the distribution of the topological map. Their joint probability is γ and

$$C ∈ {ℝ}_{+}^{s \times t}$$

is a distance matrix, calculated using the Euclidean distance, between the channel-charting coordinates and the map samples. It describes the cost to transport probability mass between the channel charting and map domain. The solution for (4) is

$$T = diag ( a ) K diag ( b ) , \qquad ( 5 )$$

where

$$K = [ {e}^{- λ {C}_{i , j}} ] ,$$

a∈ [symbol] and b∈ [symbol] and can be calculated by the Sinkhom-Knopp algorithm (see [50]).

$$a ← p ⌀ Kb and b ← q ⌀ {K}^{T} a , \qquad ( 6 )$$

where: *^{T} is the transpose of the matrix and [symbol] is the elementwise division operation. The algorithm iteratively estimates (4), while γ regularizes the stability of the convergence by controlling the entropy H(T). The higher the entropy H(T), the faster the convergence but also the less optimal the transport between the probability distributions p and q. As the algorithm only consists of linear operations it can be differentiated and thus be used as loss function

$${ℒ}_{m} = 〈 T , C 〉 \qquad ( 7 )$$

to minimize the distribution of the channel charting coordinates and the distribution of the topological map.

Now, adaptive map distribution according to embodiments is described.

Ghazvinian et al. (see [39]) assumed to know the distribution of the source domain p, or assumed a uniform distribution within the area of the topological map. This might work in scenarios, where the data recording is explicitly performed, like a person walking in a meander path through the entire environment. However, in a realistic indoor environment, e.g., an industrial production line, a uniform distribution is very unlikely. There are (temporary) inaccessible areas, like positions of machines or cordoned off areas, which cannot be entered. Also automated guided vehicles (AGVs) may not enter all areas of the environment, as their purpose is to deliver goods between storage areas. However, by anyway assuming a uniform distribution within the environment the map matching fails, as shown in the evaluation below.

According to embodiments, a small, but crucial difference to their approach is provided, which enables to learn the probabilities within the discrete map distribution. Thus, embodiments do not force to match the source domain distribution to the map, but rather penalize samples, which are outside of the possible areas.

Considering map matching of embodiments: In contrast to their work, where they learn the manifold along with the map matching simultaneously, the optimization of embodiments is split into a two stage approach. First the channel chart is estimated, which only reflects the geometry of the environment, and in the second step, a linear transformation is learned, e.g., translation t_{θ} and rotation φ_{κ}, to match the map with the learned channel chart. In other embodiments, scaling may, e.g., also be considered.

A pseudo-code of the map matching procedure is shown in Algorithm 1.

| Algorithm 1: Map matching | | | | |
|---|---|---|---|---|
| Input: Xₛ = {xᵢ}^{N}^{ₛ} ∈ Ωₛ, Yₜ = {yᵢ}^{N}^{ₜ} ∈ Ωₜ, φᵢ | | | | |
| Output: Linear transformation, i.e. t_{θ}, φ_{κ} | | | | |
| Init: q_{ζ} = [symbol] , φ_{κ} = φᵢ | | | | |
| 1 | t_{θ} = Init Translation(Xₛ, Yₜ); | | | |
| 2 | for Iᵢₜₑᵣ iterations do | | | |
| 3 | \| | B = batches(Xₛ); | | |
| 4 | \| | foreach b in B do | | |
| 5 | \| | \| | b = linTrans(b, t_{θ}, φ_{κ}); | |
| 6 | \| | \| | [symbol] ₘ = Sinkhorn(b, Yₜ, q_{ζ}) | |
| 7 | \| | \| | ${t}_{θ} ← {t}_{θ} + η \frac{\partial {ℒ}_{m}}{\partial {t}_{θ}} ;$ | |
| 8 | \| | \| | if k > I_{wt} then | |
| 9 | \| | \| | \| | ${ϕ}_{κ} ← {ϕ}_{κ} + η \frac{\partial {ℒ}_{m}}{\partial {ϕ}_{κ}} ;$ |
| 10 | \| | \| | end | |
| 11 | \| | \| | if k > I_{w\|} then | |
| 12 | \| | \| | \| | ${q}_{ζ} ← {q}_{ζ} + η \frac{\partial {ℒ}_{m}}{\partial {q}_{ζ}} ;$ |

| | | | |
|---|---|---|---|
| 13 | \| | \| | end |
| 14 | \| | end | |
| 15 | end | | |

In algorithm 1, the channel charting coordinates of the training data Xₛ, the samples of the topological map Yₜ and the initial rotation φ_{κ} are fed to the algorithm. The discrete probability distribution q_{ζ} of the map is initialized uniformly for all samples. In Line 1, the translation between the channel chart Xₛ and map Yₜ are initialized to match their centers of mass. After this, the channel charting coordinates are split into batches B due to memory constraints (Line 3) and the optimization process iterates for Iᵢₜₑᵣ epochs. The translation t_{θ} and rotation φ_{κ} are applied to the channel charting coordinates (Line 5) and the Sinkhorn distance is estimated (Line 6). In Line 7, first the Sinkhorn distance is minimized with respect to the translation t_{θ} until it converged. After I_{wt} periods, also the rotation is optimized. Once, the parameters of the linear transformation are estimated, e.g., I_{wl}, I_{wl}>I_{wt} periods, with the static map, also the probabilities of the map distribution 4 are optimized to adapt the map to the data distribution. The inventors have found that the convergence is very sensitive to the start rotations, and often ends up in local minima. Also the channel chart may have inverted x- and y-axis. Thus, according to embodiments, it is proposed to repeat the map matching algorithm several times and select the transformation parameters with the smallest Sinkhorn distance.

In the following, a positioning pipeline according to embodiments is described.

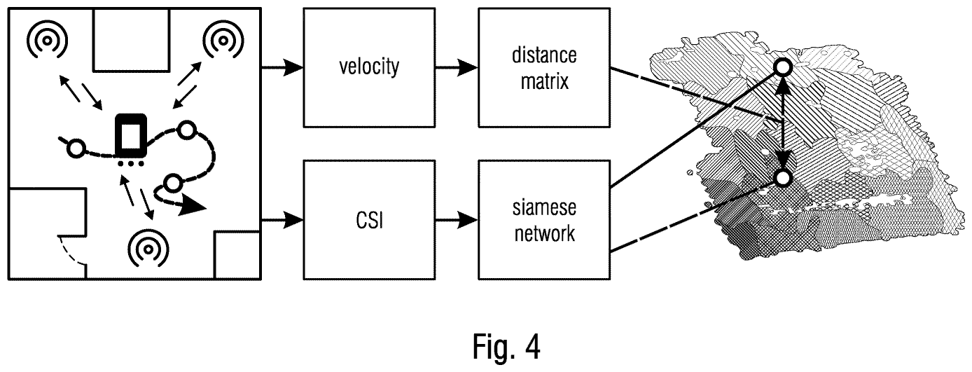

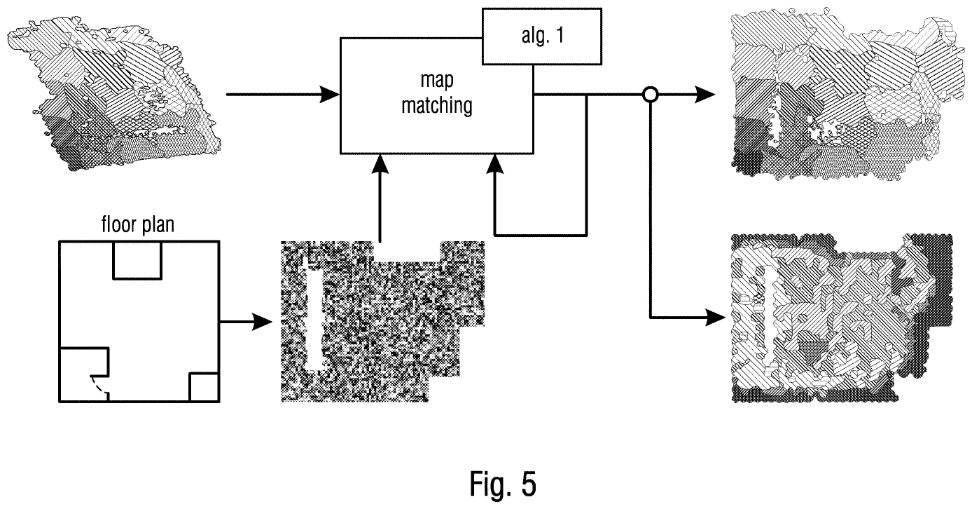

The final positioning pipeline is shown in FIG. 4 and FIG. 5 and is split into two stages:

The first stage, depicted by FIG. 4, is used to generate the channel chart, which models the relative positions of the radio unit in the environment.

The second stage, depicted by FIG. 5, estimates the transformation from the relative to the global coordinate frame by means of a topological map.

Thus, stage 1 of the positioning pipeline, depicted by FIG. 4, generates a channel chart based on CSI and velocity information.

After the channel chart is generated, which only reflects the radio geometry up to isometries, to exploit the channel chart for localization, stage 2, depicted by FIG. 5, learns a linear transformation to the real world coordinates by provided topological map information.

In the channel-charting stage, shown in FIG. 4, one or more agents move within an environment, e.g., equipped with an odometry or PDR system to estimate the velocity. While moving, the agent also communicates with a radio system (red) to record CSI (red dots). After recording, the velocity information is used to generate a sparse distance matrix between the CSI measurements, as described above. Pairs of CSI measurements are fed to the Siamese network to estimate 2D coordinates for every CSI. Eventually the loss function, described in (3), enforces the Siamese network to keep the distances between the measurements. After the training is finished the Siamese network may, e.g., estimate coordinates from given CSI measurements also on unseen data.

However, the Siamese network can only predict the coordinates up to isometries. Hence, to use it for localization a linear transformation to the real world coordinates is necessary. To completely avoid ground truth labels, according to an embodiment, a map matching algorithm as shown in FIG. 5 may, e.g., be employed. Such an embodiment only requires a topological map, e.g., a floor plan, which reflects the radio environment as good as possible. The map does not have to cover temporary inaccessible areas, but the areas where no measurements are possible, e.g., outside of the room or in areas with stationary objects, e.g., shelves in a storage hall. A discrete PDF is derived from the floor plan and fed to the map matching algorithm described above, shown as blue scatters, along with the estimated channel charting coordinates, shown as the scatters with the color gradient, from the training data distribution. The map matching algorithm learns a linear transformation, which aligns both distributions and simultaneously learns the probabilities, shown as heat map bottom right, of the map to adapt to the true data distribution of the training data. Eventually, a positioning pipeline is created, which is able to estimate the relative coordinates within the channel chart followed by a transformation to the real world coordinates learned by topological map information.

In the following, experimental setups according to embodiments are presented.

Provided embodiments have been evaluated with two different data sets and radio systems a 5G and a distributed SIMO system. The data sets do not only differ in the type of radio signals, but also in the type of motion, as the 5G dataset was recorded by a walking person while the SIMO dataset was recorded by a robot platform.

At first, a 5G experimental setup according to an embodiment is considered.

In a first experiment, a 5G uplink time-difference-of-arrival (TDoA) setup has been used with eight software-defined-radio base stations (BS). The radio system has a center frequency of 3.75 GHz with a bandwidth of 100 MHz, while the BSs are synchronized by a signal generator. The data is recorded with a frequency of 100 Hz.

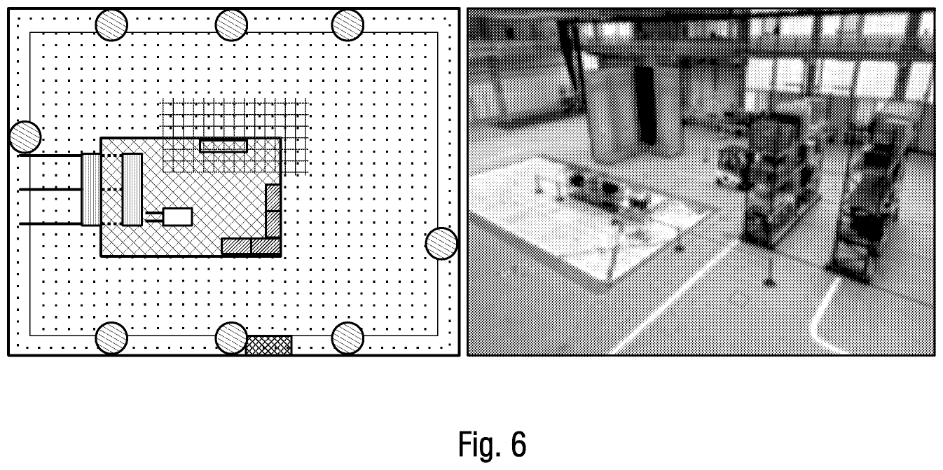

FIG. 6 illustrates a schematic top view (left) of an environment (right) of a 5G dataset according to an embodiment. Red rectangles indicate reflective walls, the green dots are the base stations, blue indicates small shelves and purple the large shelves. The recording area, indicated in blue, has a size of 20 m×10 m. In particular, FIG. 6 shows a schematic sketch of the environment on the left-hand side, while the real world is shown on the right. The base stations (green dots) are placed at the edges of the environment. The environment reflects a small industrial setup with large shelves (purple), a working desk (blue) large reflective walls (red) and a fork lift (gray). The large reflective walls block the signals on the outside, thus in the proximity of the walls the majority of the base stations have NLOS to the transmitter. Also in between the large shelves the signals to the BSs are blocked or distorted.

The transmitter is a mobile phone and thus has a directional antenna. The mobile phone is carried directly in front of a person, hence the body also shadows the signals w.r.t. the persons point of view. The statistics of the data recording are shown in Table II, wherein Table II illustrates statistics of the datasets from the radio systems.

TABLE II
STATISTICS OF THE DATASETS FROM
RADIO SYSTEMS.

| Radio | | # | Velocity [m/s] |
|---|---|---|---|
| system | Type | Samples | (Mean +− std. dev.) |
| 5G | Train | 90.417 | 0.98 +− 0.45 |
| | Train | 60.432 | 0.87 +− 0.47 |
| | Test | 18.256 | 0.93 +− 0.47 |
| SIMO | Train | 59.137 | 0.28 +− 0.10 |
| | Test | 23.478 | 0.25 +− 0.10 |

Two datasets for training have been recorded with 90.417 and 60.432 samples and a mean velocity of 0.98 m/s and 0.87 m/s. Due to the natural movement of a person with various standstill moments, the standard deviation (std. dev.) of the velocity is fairly high with 0.45 m/s and 0.47 m/s. The test trajectory is shorter with only 18.256 samples.

Now, a SIMO experimental setup according to an embodiment is considered.

For the second experiment, we utilized data from a distributed SIMO radio system (see [51]). The orthogonal frequency domain (OFDM) radio system consists of 4 BS with 2×4 antenna arrays each. The center frequency is 1.272 GHz with a bandwidth of 50 MHz. All antennas are synchronized in frequency, time and phase by means of over-the-air synchronization. The antenna of the transmitter is omnidirectional.

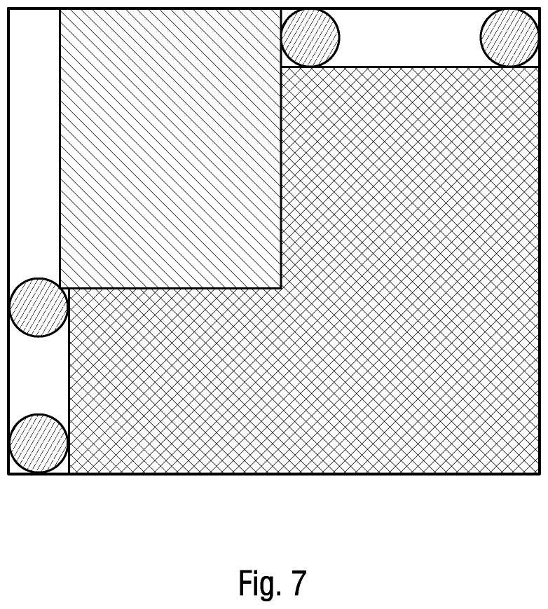

FIG. 7 illustrates a schematic top view of the environment of a SIMO dataset according to an embodiment. The orange rectangle indicates a small container room. The recording area, indicated in blue, has a size of 11 m×13 m. In particular, FIG. 7 shows the schematic top view environment. The arrays (green) are placed at the edges of the L-shaped recording area (blue) in a research factory campus environment. The environment contains a metal container room (orange), which causes NLOS and multipath propagation. Data recording is done by a robot platform. A training dataset with 59.137 samples and a test dataset with 23.478 samples are employed as shown in Table II. The velocities are slow compared to the other recordings with only 0.28 m/s for the training and 0.25 m/s for the test dataset. Also the standard deviation of the velocity is only 0.10 m/s, which indicates a slow and consistent movement.

Now, a preprocessing according to an embodiment is considered.

To generate representative representations of CSI data for a Siamese network according to an embodiment, the same preprocessing scheme as proposed in is used. The power-delay profile of the CSI data is employed, since the inventive approach does not rely on phase synchronization. A 2D input tensor is generated with the dimension of N_{A}×L_{w}, with N_{A} BS and L_{w} samples of the CSI For the 5G system, the CSIs are padded by the TDoA to reflect the relative time alignment of the in impinging signals. Since the CSI data of the SIMO system is already synchronized in time, a padding of the CSI is not needed

In the following, maps according to embodiments are considered.

To learn a transformation from the local channel charting coordinates, map information can be used as described above. The map consists of discrete positions within the area of the topological map and has to provide a unique match of the channel chart within the map.

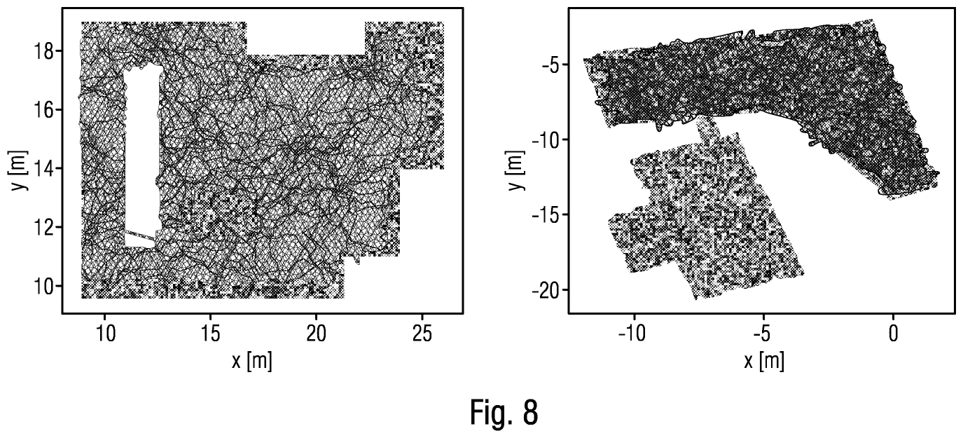

FIG. 8 illustrates a topological map of a 5G dataset (left) and the SIMO dataset (right) according to an embodiment. The map coordinates are shown in blue, while the orange trajectories show the training datasets. The number of samples within the map has to be large enough to cover all areas in the map, while the size is limited to the GPU memory as we have to calculate a distance matrix with the channel charting coordinates. We found experimentally that a size of 5000 samples is large enough for both environments. Each of the points require a probability, which describes how likely it is that channel chart coordinates are placed at this position. Since the spatial density of the channel charts is not known, as ground truth reference positions are not available, a uniform probability may, e.g., be assigned to all the map coordinates. The 5G map is restricted to the recording area, indicated in blue in FIG. 6). All static objects in the environment, i.e., the large metal shelves on the left hand side, the big reflecting walls and the work desks are considered. However, the fork lift is not included in the map as the position of the object changes regularly and would also neither be included in a floor plan. The map of the SIMO dataset is derived from the ground truth coordinates of the training data distribution, as we have to information about the composition of the environment. Beside the area, which covers the training data trajectories, an artificial room is added with no data included. It is intended to simulate an area in the map the robot cannot access, hence there is no data available. However, the training data, and thus the channel chart, still has a unique match to the map.

Now, velocity simulation according to an embodiment is considered.

Velocity estimation by odometry or PDR systems is often error prone due to slipping wheels, varying tire pressure, wrong step length estimation or drifting IMU sensors. The effect of different error sources of the velocity estimation on the channel charting performance according to embodiments is investigated. As the recorded datasets do not provide velocities, the true velocities are estimated by the ground truth labels and different error sources summarized in Table Ill are added.

Table III depicts five different noise levels with a bias in the angular velocity (ang. bias). A bias in the magnitude of the velocity (mag. bias) and instantaneous rotations (inst. Rotations). The inst. rotations are defined by a position within the trajectory, as percentage of the trajectory, and an angle [pos., ang.].

TABLE III

| | | ang. bias | mag. bias | inst. rotations |
|---|---|---|---|---|
| | | rad/s | m/s | (pos/ang.) |
| Noise | 0 | — | — | — |
| level | 1 | — | — | $[ 5 , \frac{π}{4} ] , [ 20 , - \frac{π}{8} ] , [ 60 , - \frac{π}{6} ]$ |
| | 2 | $\frac{π}{200}$ | — | $[ 5 , \frac{π}{4} ] , [ 40 , - \frac{π}{8} ] , [ 60 , - \frac{π}{6} ]$ |
| | 3 | $\frac{π}{100}$ | — | $[ 5 , \frac{π}{4} ] , [ 40 , - \frac{π}{8} ] , [ 60 , - \frac{π}{6} ]$ |
| | 4 | $\frac{π}{200}$ | −0.1 | $[ 5 , \frac{π}{4} ] , [ 40 , - \frac{π}{8} ] , [ 60 , - \frac{π}{6} ]$ |

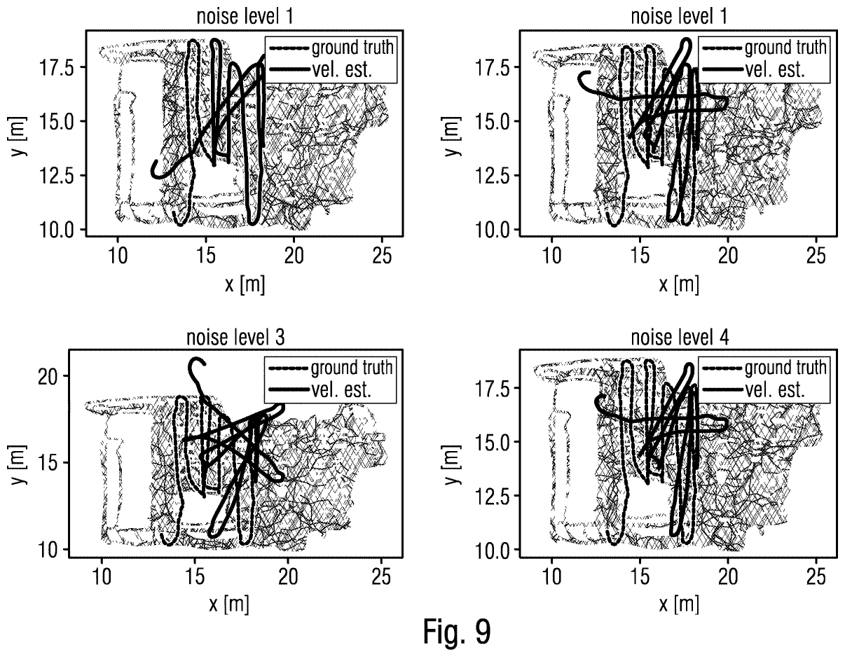

Three different error sources are considered, a bias in the angular velocity (ang. bias), e.g., caused due to a drifting gyroscope, a bias in the magnitude of the velocity (mag. bias), e.g., caused due to wrong step length estimation and instantaneous rotations (inst. rotations), e.g., caused due to exceeding the sensitivity limitations of a gyroscope. In total five noise levels are considered with increasing difficulty. Noise level 1 to 4 are depicted in FIG. 9. In particular, FIG. 9 illustrates example trajectories of noise levels 1 to 4 according to an embodiment. The full trajectory is shown in blue, while a 60 s window is marked in orange. The trajectory estimated from the noisy velocity is highlighted in green.

The impact of the noise levels on the trajectory estimation is demonstrated with the 5G training dataset. The entire trajectory is shown in blue, a ground truth window of 60 s in orange and the estimated trajectory calculated from the noisy velocities in green. The first (0) noise level is noise free, i.e., the velocity is ideal, while second noise level (1) only contains three different instantaneous rotations, while there are no biases in the angular velocity and magnitude. In the third noise level (2) a minor drift of the angular velocity is added along with instantaneous rotations, while the angular velocity bias is doubled in noise level four (3). The last noise level (4), added a magnitude bias along with a minor drift of the angular velocity and instantaneous rotations.

In the following, the experimental setups are evaluated. In particular, the velocity based channel charting is evaluated followed by the adaptive map matching. All channel charts are trained for 10.000 epochs to ensure the convergence of the networks. For the training of the 5G models, we used both training datasets for training, described in Table II while there is only one training dataset for the SIMO dataset. For the distance matrix generation, a stride length s=10 has been used for the 5G datasets, and a stride length s=2 for the SIMO dataset has been used. The training data has been employed to optimize the channel chart and to learn the linear transformation with the map matching algorithm. The evaluations are done on separate test datasets on different trajectories to investigate the generalization to unseen data.

At first, the number of BS is considered.

In particular, the abilities of channel charting according to embodiments with different numbers of base stations have been evaluated. The idea is to investigate the required spatial information contained in the input data to model the manifold only using a sparse distance matrix. A sufficiently large window has thus been used to cover large distances within the trajectories. In the case of 5G, 15 s have been used, there has been a mean velocity of 1 m/s and thus there are trajectories with the lengths of about 15 m. For the SIMO dataset, a window size of 60 s has been used, as the agent moves only about 0.28 m/s in average, which leads to distances of about 17 m within one window. A detailed analysis about the impact of the window sizes is shown below. The velocity-based channel-charting approach has been directly compared with supervised fingerprinting. As fingerprinting model, the same model as for the Siamese network has been used, and the output has been optimized directly to the ground truth coordinates of the CSI values by means of the euclidean distance loss as proposed in [12]. The results are shown in Table IV. Table IV depicts localization results for channel charting (CC) according to an embodiment compared to fingerprinting (FP) for different numbers of base stations (BS). The error is the 90th percentile of the circular error (CE90).

TABLE 4

| | | # BS/Error (CE90 in m) | | | | | | | |
|---|---|---|---|---|---|---|---|---|---|
| | | 1 | 2 | 3 | 4 | 5 | 6 | 7 | 8 |
| 5G | CC | — | 5.31 | 1.26 | 1.21 | 1.23 | 0.97 | 0.92 | 0.82 |
| | FP | — | 2.69 | 1.30 | 1.14 | 2.58 | 1.09 | 0.98 | 1.07 |
| SIMO | CC | 1.23 | 0.63 | 0.56 | 3.25 | — | — | — | — |
| | FP | 1.11 | 0.71 | 0.56 | 0.52 | — | — | — | — |

As the TDoA values of the 5G radio system have been used to create the input tensors for the Siamese network, at least two base stations are needed, while the SIMO radio system only consists of up to 4 base stations.

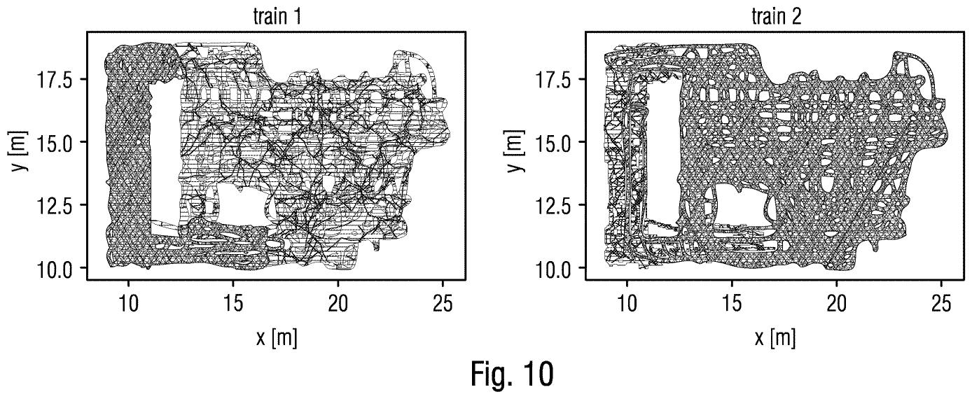

The results show that the velocity based channel charting approach according to embodiments achieves similar results to the fingerprinting model in the most cases. In the 5G setup with only two BS, the localization accuracy is higher for the fingerprinting compared to the CC, which indicates that the Siamese network might not have enough information available to model the manifold. However, with a higher number of BS, the Siamese network successfully learned the manifold to be similar to the fingerprinting model. To train the 5G model, two different datasets were used with independent trajectories shown in FIG. 10.

FIG. 10 illustrates trajectories of the training datasets, denoted in Table II according to an embodiment. The blue trajectory shows the combined datasets/the combined trajectory, while the trajectories of the specific datasets are shown in orange. The left plot shows the first training dataset and the right shows the second.

The first training dataset (left) is focused on the left hand side of the area, while the second training dataset is more focused on the right area. Both datasets have no connection in the distance matrix. However, they overlap in some particular area, which means that they have similar CSI included in their trajectories. The Siamese network managed to combine both datasets into a single channel chart, which indicates that the Siamese network successfully learned the underlying manifold not only based on the distances provided by the velocity estimation but on the data itself.

In the SIMO evaluation, the results are also similar to the fingerprinting model despite the case with four BS.

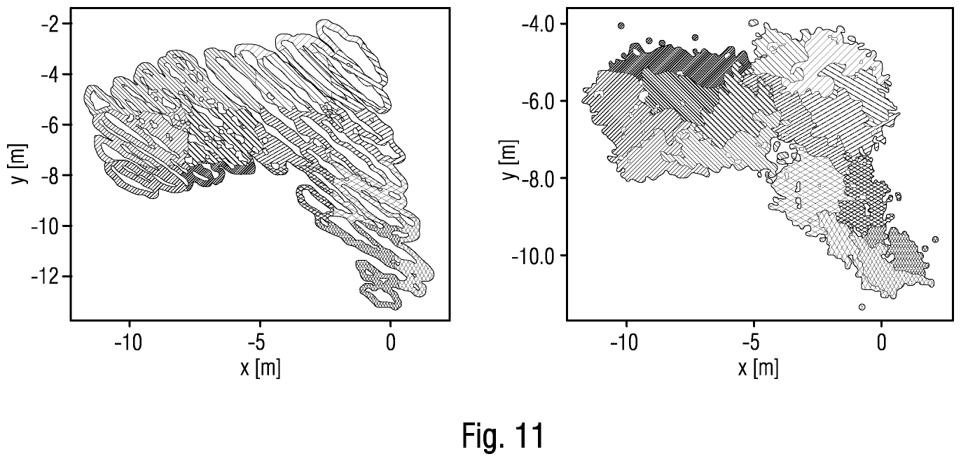

FIG. 11 illustrates the ground truth locations on the left hand side, while the channel chart according to an embodiment is shown on the right hand side. The color gradient shows the spatial consistencies of the positions. The channel chart still shows good spatial consistency, as the gradient is well recovered. However, in the area x<−5, the channel chart appears to be twisted around the x-axis. The training has been repeater for 50 times and it has been found that only in 30 trials the Siamese network converged to the correct solution, while the other 20 trials failed similar to the chart shown in FIG. 11. The mean of the Pearson correlation coefficients (PCCs) of the CSI has been calculated for all BS combinations including all antennas of every BS, shown in Table V.

Table V illustrates the mean PCC for every BS combination.

TABLE V

| | BS1 | BS2 | BS3 | BS4 |
|---|---|---|---|---|
| BS1 | 1 | 0.61 | 0.86 | 0.62 |
| BS2 | 0.61 | 1 | 0.65 | 0.73 |
| BS3 | 0.86 | 0.65 | 1 | 0.63 |
| BS4 | 0.62 | 0.73 | 0.63 | 1 |

From Table V, it can be seen that there are strong correlations between pairs of BS, with a PCC of 0.86 for the combinations BS1 and BS3, and 0.73 for the combinations BS2 and BS4. While the BSs are very similar in the signal space, they are placed at different locations in the environment. This seems to be that due to redundancy, the manifold is ambiguous and may has several representations in the 2D space. By comparing the results of the fingerprinting for 3BS and 4BS, there can also be seen no significant improvement. Hence, the 4th BS does not add any useful additional information to improve the fingerprint. By removing one BS, our Siamese network converged reliably, as the symmetry and redundancy of the data has been broken.

In the following, the relation between window size and noise level is considered.

In particular, the quality of the channel charting has been investigated with erroneous velocity estimations. Like in the previous evaluation, the channel charting has been investigated isolated from the map matching and use the ground truth data for the linear transformation to the real world coordinates.

The algorithm has been evaluated for the five different noise levels described above with four different windows sizes for 5 s, 15 s, 30 s and 60 s. For the training of the 5G setup, eight BS have been used, and for the SIMO setup, three BS have been employed.

Table VI depicts results of the channel charting for different noise levels and window sizes for the 5G dataset and for the SIMO dataset.

TABLE VI

| Radio | Window | Noise level/Error (CE90 in m) | | | | |
|---|---|---|---|---|---|---|
| system | size [s] | 0 | 1 | 2 | 3 | 4 |
| 5G | 5 | 1.309 | 6.504 | 6.526 | 6.396 | 1.660 |
| | 15 | 0.912 | 0.886 | 0.856 | 0.892 | 0.927 |
| | 30 | 0.870 | 0.901 | 0.876 | 0.961 | 0.935 |
| | 60 | 0.871 | 0.841 | 0.947 | 1.112 | 0.968 |
| SIMO | 5 | 4.562 | 3.397 | 5.064 | 4.733 | 4.754 |
| | 15 | 3.235 | 0.675 | 3.660 | 2.863 | 2.627 |
| | 30 | 0.543 | 0.551 | 0.60 | 0.696 | 0.699 |
| | 60 | 0.537 | 0.566 | 0.70 | 0.951 | 0.895 |

The results, summarized in Table VI clearly show that the window size has relevance in modeling the manifold of the CSI data.

Velocity based channel charting fails for both datasets with only a window size of 5 s. While the 5G dataset can achieve good results for window sizes of 15 s and larger, the SIMO dataset needs at least a window of 30 s to achieve a stable result. We think that the needed window sizes correlates with the velocity of the agent. In the case of the 5G dataset, the agent had a mean velocity of about 0.95 m/s, while the mean velocity was much lower in the SIMO dataset with only 0.28 m/s. Hence, the distances estimated by the velocities were only small in the SIMO dataset compared to the 5G dataset, which means that the Siamese network was not able to model a globally valid channel chart only based on local distances.

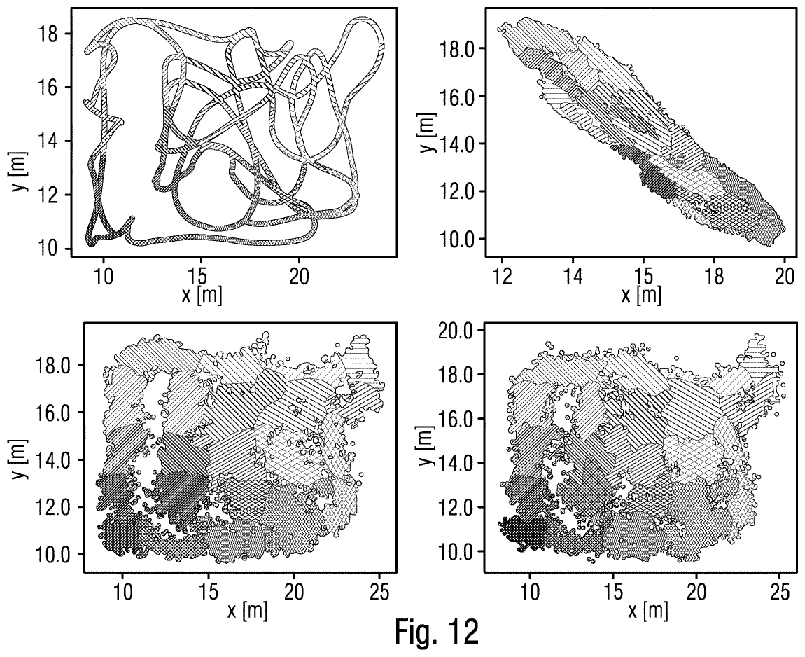

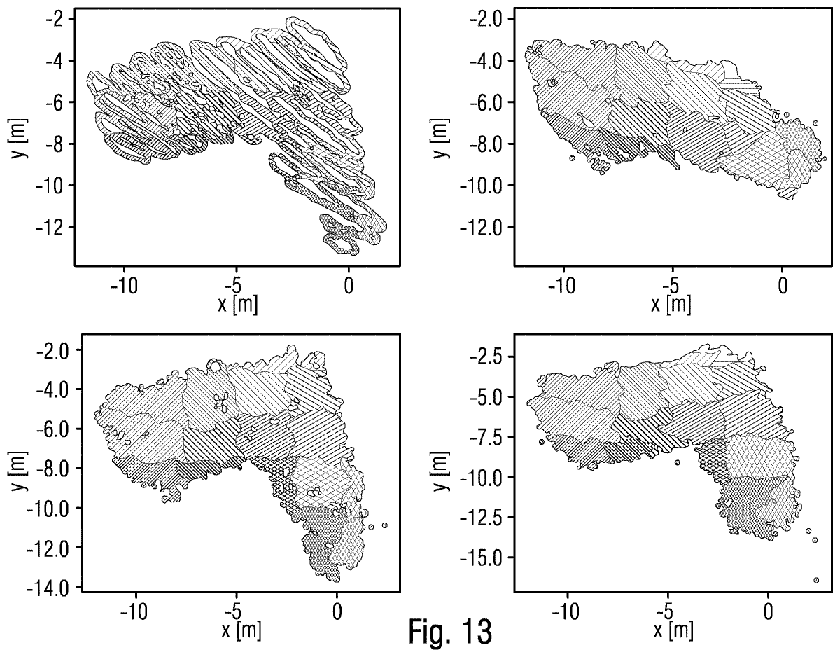

FIG. 12 illustrates channel charts for a 5G dataset generated with different time windows according to an embodiment. In the top left corner, the ground truth trajectory of the test dataset is shown. In the other tiles, the channel chart for 5 s (top right), 15 s (bottom left) and 60 s (bottom right) are shown. All channel charts show a good spatial consistency, while the 5 s does not recover the global geometry of the test data. The best results were achieved by the 15 s window, almost comparable to the results of supervised fingerprinting with a CE90 of about 0.87 m for all noise levels for the channel chart and 0.82 m for the fingerprinting. The results got worse with a window size of 60 s with an increasing noise level from a CE90 of 0.84 m for noise level 1 up to 1.11 m for noise level 3. This is due to accumulating errors of the noisy velocity information. The larger the window, the larger also the errors in the distance estimations, which leads to a worse channel charting performance. However, the window size has to be sufficiently large to recover the global structure of the radio environment. Similar results can be seen in the SIMO evaluation shown in FIG. 13.

FIG. 13 illustrates channel charts for the SIMO dataset according to an embodiment, generated with different time windows, wherein In the top left corner, the ground truth trajectory of the test dataset is shown, and wherein in the other tiles, the channel charts for 15 s (top right), 30 s (bottom left) and 60 s (bottom right) are shown.

The ground truth trajectory (top left), is well recovered by the channel chart for the 30 s window (bottom left). With noise level 1 with a CE90 of 0.55 m, the accuracy of fingerprinting (0.56 m) can be achieved, while the accuracy decreases with higher noise levels of up to 0.69 m for noise level 4.

In the following, adaptive map matching is considered.

Since channel charting can model the radio geometry only up to isometries, a transformation to the real world coordinates is necessary. In the following we evaluate our adaptive map matching algorithm, enabling the real world transformation on coarse, topological information. For the evaluation, a velocity noise level 3 has been used for both datasets, a window size of 15 s has been used for the 5G dataset, and a window size of 30 s has been used for the SIMO dataset. For all experiments, Iᵢₜₑᵣ=150 iterations has been employed for training, with I_{wt}=50 and I_{wl}=100 for the warm-up periods and λ=30. The batch size shall be large enough to reflect the data-distribution in the environment. A batch size of 3000 samples has been found to be sufficiently large for the examined environments. The map matching algorithm has been repeated 60 times, with 20 different equi-distant start rotations in the range of [0, 2π) and inversions of the x- and y-axis, and the transformation with the smallest Sinkhorn distance has been selected. The results are shown in Table VII.

Table VII depicts the results (CE90) of the map matching algorithms.

TABLE VII

| Type | Least sq. | Learn. map | Static map | Comb. |
|---|---|---|---|---|
| 5G | 0.92 | 1.16 | 1.71 | 3.43 |
| SIMO | 0.71 | 0.90 | 9.65 | 11.08 |

Two baselines have been used to compare the approach of embodiments (Learn. map). The first baseline (Static map) is similar to our map matching algorithm, while the probabilities of the map along with the linear Transformation have not been learned. This can be achieved by setting I_{wl}>Iᵢₜₑᵣ. The second baseline (Comb.) follows the idea of by learning the manifold of the data simultaneously to the map matching. The same Siamese networks described above have been used, but the combined loss L=Lₘ+L_{d} has been employed to optimize the neural network. As upper bound of the approach of embodiments, the results have been provided with a linear transformation estimated by the ground truth of the training data via least squares optimization (Least sq.).

The results show that the approach of embodiments is close to the optimal linear transformation, with a CE90 of 1.16 m for the 5G dataset and a CE90 of 0.90 m for the SIMO data.

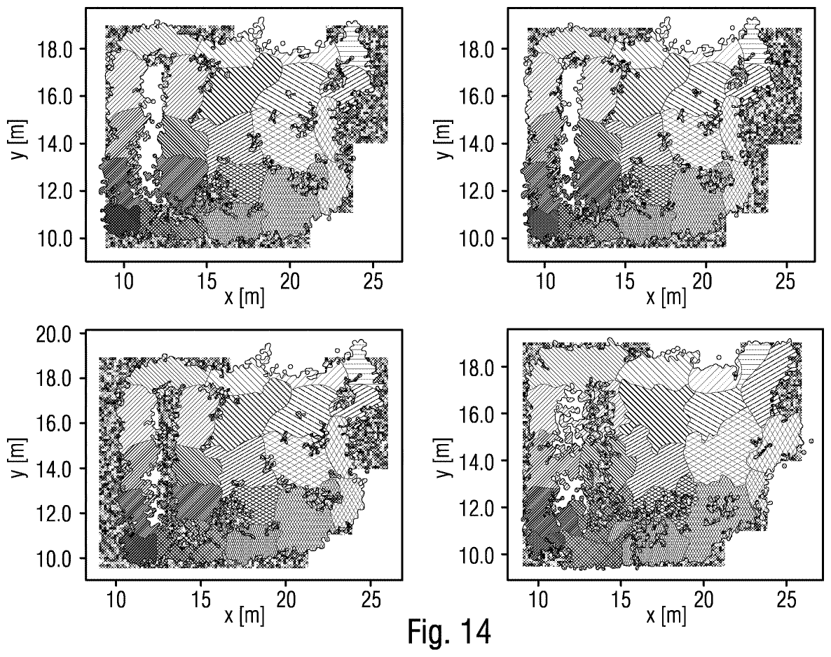

FIG. 14 illustrates results of the map matching algorithms for the 5G dataset according to an embodiment, wherein the plot top left shows the least squares approach, top right shows the map matching with a trainable map distribution, bottom left the map matching with a static map and bottom right the combined approach. The blue dots show the samples of the map distribution and the dots with the color gradient the channel chart.

In particular, FIG. 14 shows the map matching of the 5G dataset for least squares approach (top left), the approach according to an embodiment (top right), the static map approach (bottom left) and the combined approach (bottom right). The approach of embodiments has a very similar match of the channel chart on the map compared to the least squares optimization. There is only a small difference in the rotation. The static map approach has a higher error with a CE90 of 1.71 m due to a wrong horizontal alignment, as the channel chart is shifted to the right hand side. This is due to the simplified assumption that the data has a uniform distribution within the map.

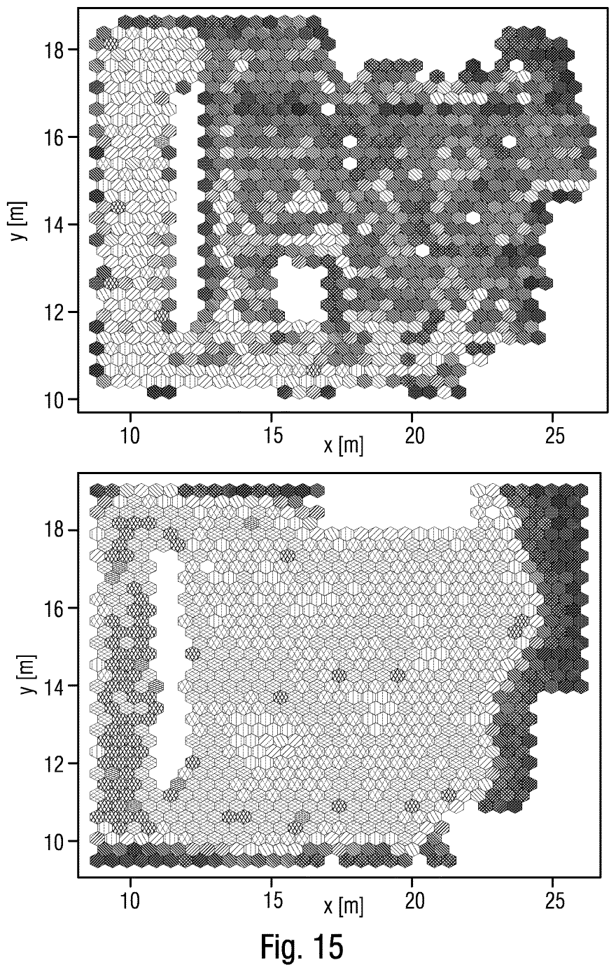

FIG. 15 illustrates a distribution of the data of the 5G dataset according to an embodiment within the environment on the left, while the learned map according to an embodiment is shown on the right. The color indicates the probability, while blue is low and red is high. In particular, FIG. 15 illustrates on the left hand side the distribution of the positions of the training dataset. It can clearly be seen that there is a higher density of data at the large shelf on the left hand side compared to the area on the right hand side. Thus, the channel charting coordinates are pushed more towards the right hand side for a better overlap of the probability masses. The combined approach has a similar problem with an even higher CE90 of 3.43 m. While the channel chart coordinates match the area of the map very well, the Siamese network tries to match the uniform distribution of the map. Hence, points of the left hand side are pushed towards the right hand side to match the map distribution. In contrast, our approach learns the distribution of the probability mass within the map shown in FIG. 15. The distribution of the probability mass of within the map is shown on the right hand side, while blue means low probability and red high. It can clearly be seen that the probability mass adapted very well to the distribution of the data, shown on the left hand side. All areas outside of the area of the training data are assigned a low probability, while the area on the left hand side has a higher probability like in the data distribution.

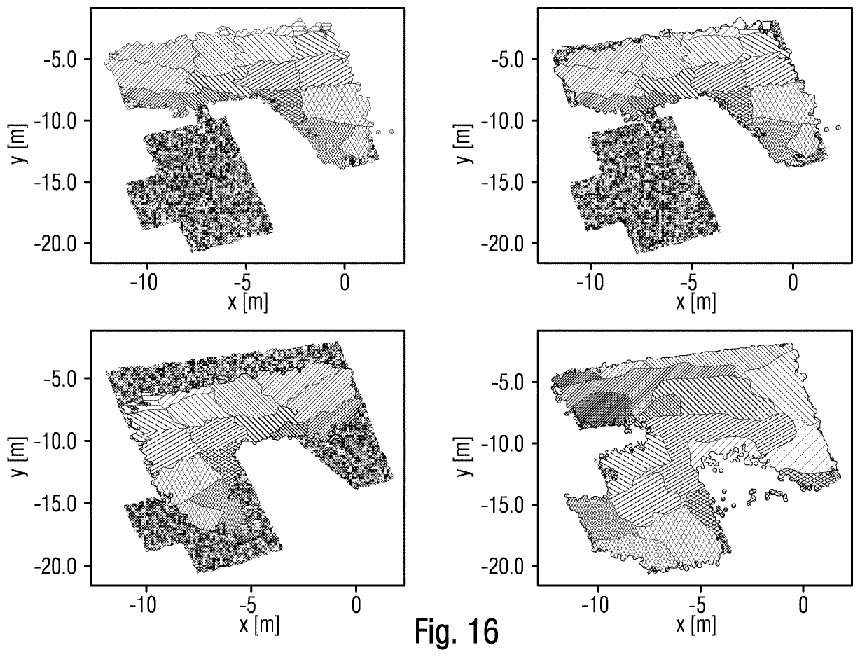

FIG. 16 illustrates results of the map matching algorithms for the SIMO dataset, wherein the plot top left shows the least squares approach, top right shows the map matching with a trainable map distribution according to an embodiment, bottom left the map matching with a static map and bottom right the combined approach. The blue dots show the samples of the map distribution and the dots with the color gradient the channel chart.

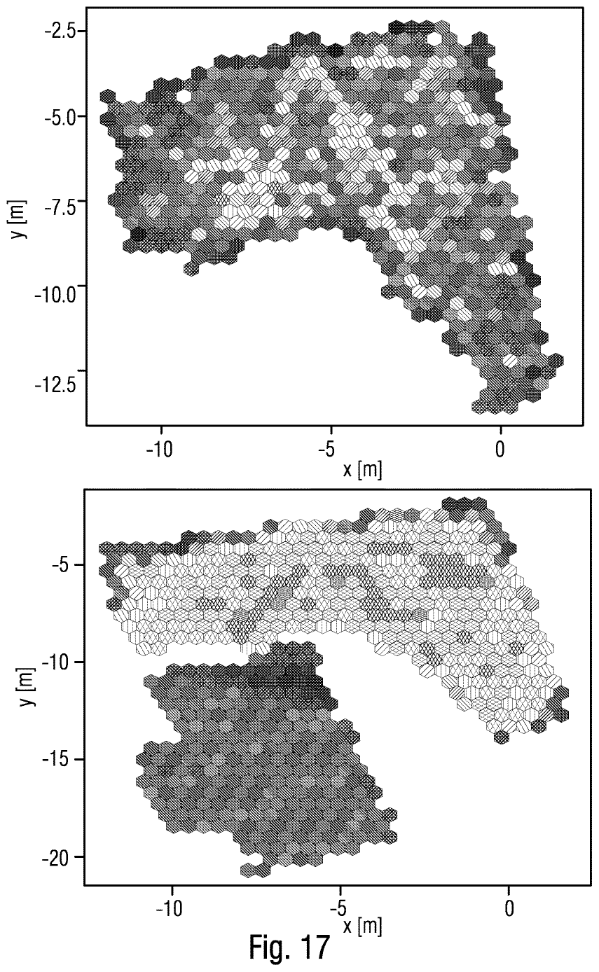

Similar results as in FIG. 15 can be seen for the SIMO dataset in FIG. 16. Again, the method according to an embodiment has a small error in the rotation compared to the least squares approach, while the static map method fails completely. Since we evaluate our map matching algorithm with various starting parameters and select the best transformation with respect to the final Sinkhorn distance, the lowest Sinkhorn distance to a uniform distribution within the map leads to a wrong alignment and thus to a high localization error. Also the combined approach achieved a poor localization performance with a CE90 of 11.08 m. The Siamese network matches the map, despite that in the room area no data was recorded. While the local spatial consistency is still good, i.e., the color gradient is still visible, the Siamese network assign coordinates to the room, which is not covered by the data distribution. The approach of an embodiment solves this problem by learning that the room does not contain any data points, as shown in FIG. 17

FIG. 17 illustrates a distribution of the data of the SIMO dataset within the environment on the left, while the learned map is shown on the right. The color indicates the probability, while blue is low and red is high. The left plot shows the distribution of the data, while the right hand side shows the distribution of the probability mass within the map. The algorithm according to an embodiment is able to align the channel chart at the correct position, while learning that the room is not covered by the training data. Also, this solution ended up with the lowest Sinkhorn distance, as every other alignment of the channel chart would lead to channel chart coordinates outside of the map area and thus to a higher Sinkhorn distance.

In the following, further considerations are made.

The experiments have shown that the velocity based channel charting algorithm according to embodiments can achieve accuracies similar to supervised fingerprinting, while being independent to radio topologies and architectures. However, the global consistency relies on the length of the trajectories considered in the distance matrix, which also means that the time windows may have to be longer for agents with smaller velocities. For the 5G dataset, time windows of 15 s were sufficiently large, while for the SIMO dataset at least 30 s were required. Thus, in some embodiments, the trajectories shall to cover a substantial part of the environment to achieve global consistency of the channel chart. Hence, the scaling to large environments may be restricted. A possible solution according to an embodiment is to split the channel charts into distinct areas of limited size and switch between the models as shown in [18]. However, as we can not spatially separate the recorded data, since there is no ground truth information, and external area identification may, e.g., be employed. Another problem is that the error characteristics often do not depend on the movement speed of the agent like a bias in the angular velocity. Thus, slower agents may have more erroneous position estimations and hence distance errors, while faster agents may have better results with the same error characteristics. In consequence, the quality of the distance estimation and therefore on the channel chart not only depends on the quality of the velocity estimation system itself, but also on the movement pattern of the agent.

To transform the local channel charting coordinates into the real world environment, we have shown how to use topological map information, e.g. a floor plan, which only reflects the coarse geometry of the environment. While embodiments achieve superior results compared to the state of the art, the map matching algorithm works particularly well, if there is a unique match of the channel chart in the map. This restricts the map matching to rotation and translation invariant map information, and does not work equally well for e.g. rectangular areas, if there are no unique features included like shelves or work desks. Also the density and distribution of the channel chart is crucial for the map matching. While the map could provide a translation and rotation invariant assignment due to unique features, the channel chart also benefits from a complete coverage of the areas around those features to avoid miss-alignment.

The map matching algorithm according to embodiments works particularly well with linear transformation with only rotation and translation. However, scaling errors due to e.g. wrong step estimation e.g. in noise level 4, are hard to learn along with the probabilities of the map. The map matching algorithm would scale the channel chart down and assign it to an arbitrary area, while learning that the surrounding areas have not data assigned. Thus, before map matching the scale of the channel chart may, e.g., be estimated.

According to some embodiments, a framework for unsupervised fingerprinting only requiring velocity estimation and/or topological map information has been provided. The velocity-based channel charting approach can achieve accuracies of up to a CE90 of 0.93 m for a 5G and 0.70 m for a SIMO radio system, similar to supervised fingerprinting, even with very noisy velocity estimation. Hence, the approach pf embodiments is robust to noisy velocity estimation, which makes it applicable for low cost sensor systems like smartphone based PDR or odometry of robot platforms.

The adaptive map matching of embodiments enables the usage of topological map information like floor plans to learn a transformation of the local channel charting coordinates to the real world environment. In contrast to the state of the art, the map matching algorithm of embodiments only needs a coarse representation of the environment as it learns to adapt the map while it aligns the channel chart to the real world coordinates.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] C. Laoudias, A. Moreira, S. Kim, S. Lee, L. Wirola, and C. Fischione, “A Survey of Enabling Technologies for Network Localization, Tracking, and Navigation,” IEEE Communications Surveys & Tutorials, vol. 20, no. 4, pp. 3607-3644, 2018.
[2] N. Saeed, H. Nam, T. Y. Al-Naffouri, and M.-S. Alouini, “A State-of-the-Art Survey on Multidimensional Scaling-Based Localization Techniques,” IEEE Communications Surveys & Tutorials, vol. 21, no. 4, pp. 3565-3583, 2019.
[3] Y. Wu, F. Tang, and H. Li, “Image-based camera localization: an overview;” Visual Computing for Industry, Biomedicine, and Art, vol. 1, no. 8, 2018.
[4] M. Elhousni and X. Huang, “A Survey on 3D LiDAR Localization for Autonomous Vehicles,” in IEEE Intelligent Vehicles Symposium (IV). Las Vegas, NY, USA: IEEE, 2020, pp. 1879-1884.
[5] A. M. Rahman, T. Li, and Y. Wang, “Recent Advances in Indoor Localization via Visible Lights: A Survey,” Sensors, vol. 20, no. 5, p. 1382, 2020.
[6] F. Pang, K. Doğançay, N. H. Nguyen, and Q. Zhang, “AOA Pseudolinear Target Motion Analysis in the Presence of Sensor Location Errors,” IEEE Transactions On Signal Processing, vol. 68, pp. 3385-3399, 2020.
[7] H.-C. Yen, L.-Y. O. Yang, and Z.-M. Tsai, “3-d indoor localization and identification through rssi-based angle of arrival estimation with real wi-fi signals,” IEEE Transactions on Microwave Theory and Techniques, vol. 70, no. 10, pp. 4511-4527, 2022.
[8] W. Gifford, D. Dardari, and M. Win, “The Impact of Multipath Information on Time-of-Arrival Estimation,” IEEE Transactions on Signal Processing, vol. 70, pp. 31-46, 2020.
[9] M. Stahlke, S. Kram, C. Mutschler, and T. Mahr, “NLOS Detection using UWB Channel Impulse Responses and Convolutional Neural Networks,” in International Conference on Localization and GNSS (ICL-GNSS). Tampere, Finland: IEEE, 2020.
[10] M. Stahlke, S. Kram, F. Ott, T. Feigl, and C. Mutschler, “Estimating TOA Reliability With Variational Autoencoders;* IEEE Sensors Journal, vol. 22, no. 6, pp. 5133-5140, 2021.
[11] A. Niitsoo, T. Edelhäußer, E. Eberlein, N. Hadaschik, and C. Mutschler, “A Deep Learning Approach to Position Estimation from Channel Impulse Responses; Sensors, vol. 19, no. 5, p. 1064, 2019.
[12] M. Stahlke, T. Feigl, M. H. C. Garcia, R. A. Stirling-Gallacher, J. Seitz, and C. Mutschler, “Transfer Learning to adapt 5G AI-based Fingerprint Localization across Environments,” in IEEE 95th Vehicular Technology Conference (VTC2022-Spring). Helsinki, Finland: IEEE, 2022.
[13] K. Liu, H. Zhang, J. K.-Y. Ng, Y. Xia, L. Feng, V. C. Lee, and S. H. Son, “Toward Low-Overhead Fingerprint-Based Indoor Localization via Transfer Learning: Design, Implementation, and Evaluation,” IEEE Transactions On Industrial Informatics, vol. 14, no. 3, pp. 898-908, 2017.
[14] S. De Bast, A. P. Guevara, and S. Pollin, “CSI-based Positioning in Massive MIMO systems using Convolutional Neural Networks,” in IEEE 91st Vehicular Technology Conference (VTC2020-Spring). Antwerp, Belgium: IEEE, 2020.
[15] M. Widmaier, M. Arnold, S. Dorner, S. Cammerer, and S. ten Brink, “Towards Practical Indoor Positioning Based on Massive MIMO Systems,” in IEEE 90th Vehicular Technology Conference (VTC2019-Fall). Honolulu, HI, USA: IEEE, 2019.
[16] N. Singh, S. Choe, and R. Punmiya, “Machine learning based indoor localization using wi-fi rssi fingerprints: an overview,” IEEE Access, 2021.
[17] B. Jia, J. Liu, T. Feng, B. Huang, T. Baker, and H. Tawfik, “Ttsl: An indoor localization method based on temporal convolutional network using time-series rssi;’ Computer Communications, vol. 193, pp. 293-301, 2022.
[18] M. Stahlke, T. Feigl, S. Kram, B. Eskofier, and C. Mutschler, “Uncertainty-based fingerprinting model selection for radio localization,” in 2023 IEEE 13th Intermational Conference on Indoor Positioning and Indoor Navigation (IPIN), 2023.
[19] C. Studer, S. Medjkouh, E. Gonultaş. T. Goldstein, and O. Tirkkonen, “Channel Charting: Locating Users Within the Radio Environment Using Channel State Information,” IEEE Access, vol. 6, pp. 47682-47698, 2018.
[20] M. Stahlke, G. Yammine, T. Feigl, B. M. Eskofier, and C. Mutschler, “Indoor localization with robust global channel charting: A time-distance-based approach,” IEEE Transactions on Machine Learning in Communications and Nerworking, vol. 1, pp. 3-17, 2023.
[21] P. Stephan, F. Euchner, and S. t. Brink, “Angle-delay profile-based and timestamp-aided dissimilarity metrics for channel charting,” arXiv preprint arXiv: 2308.09539, 2023.
[22] L. Le Magoarou, “Efficient Channel Charting via Phase-Insensitive Distance Computation,” IEEE Wireless Communications Letters, vol. 10, no. 12, pp. 2634-2638, 2021.
[23] P. Agostini, Z. Utkovski, and S. Stańczak, “Channel Charting: an Euclidean Distance Matrix Completion Perspective,” in IEEE International Conference on Acoustics, Speech and Signal Processing (ICASSP). Barcelona, Spain: IEEE, 2020, pp. 5010-5014.
[24] R. Schmidt, “Multiple Emitter Location and Signal Parameter Estimation,” IEEE Transactions on Antennas and Propagation, vol. 34, no. 3, pp. 276-280, 1986.
[25] F. Euchner, P. Stephan, M. Gauger, S. Domer, and S. Ten Brink, “Improving Triplet-Based Channel Charting on Distributed Massive MIMO Measurements,” in IEEE 23rd International Workshop on Signal Processing Advances in Wireless Communication (SPAWC). Oulu, Finland: IEEE, 2022.
[26] H. Al-Tous, O. Tirkkonen, and J. Liang, “Adaptive Sector Splitting based on Channel Charting in Massive MIMO Cellular Systems,” in IEEE 93rd Vehicular Technology Conference (VTC2021-Spring). Helsinki, Finland: IEEE, 2021.
[27] H. Al-Tous, T. Ponnada, C. Studer, and O. Tirkkonen, “Multipoint channel charting-based radio resource management for v2v communications,” EURASIP Journal on Wireless Communications and Networking, no. 132, 2020.
[28] T. Ponnada, H. Al-Tous, and O. Tirkkonen, “Location-Free Beam Prediction in mmWave Systems,” in IEEE 93rd Vehicular Technology Conference (VTC2021-Spring). Helsinki, Finland: IEEE, 2021, pp. 1-6.
[29] T. Ponnada, P. Kazemi, H. Al-Tous, Y.-C. Liang, and O. Tirkkonen, “Best Beam Prediction in Non-Standalone mm Wave Systems,” in Joint European Conference on Networks and Communications & 6G Summit (EuCNC/6G Summit). Porto, Portugal: IEEE, 2021, pp. 532-537.
[30] P. Kazemi, T. Ponnada, H. Al-Tous, Y.-C. Liang, and O. Tirkkonen, “Channel Charting Based Beam SNR Prediction,” in Joint European Conference and Networks and Communications & 6G Summit (EuCNC/6G Summit). Porto, Portugal: IEEE, 2021, pp. 72-77.
[31] L. Ribeiro, M. Leinonen, H. Djelouat, and M. Juntti, “Channel Charting for Pilot Reuse in mMTC with Spatially Correlated MIMO Channels,” in IEEE Globecom Workshops. Taipei, Taiwan: IEEE, 2020.
[32] S. Taner, V. Palhares, and C. Studer, “Channel charting in real-world coordinates,” arXiv preprint arXiv: 2308.14498, 2023.
[33] E. Lei, O. Castaneda, O. Tirkkonen, T. Goldstein, and C. Studer, “Siamese Neural Networks for Wireless Positioning and Channel Charting,” in 57th Annual Allerton Conference on Communication, Control, and Computing (Allerton). Monticello, IL, USA: IEEE, 2019, pp. 200-207.
[34] P. Ferrand, A. Decurninge, L. G. Ordoñez, and M. Guillaud, “Triplet-Based Wireless Channel Charting: Architecture and Experiments,” IEEE Journal on Selected Areas in Communications, vol. 39, no. 8, pp. 2361-2373, 2021.
[35] J. Deng, O. Tirkkonen, J. Zhang, X. Jiao, and C. Studer, “Network-side Localization via Semi-Supervised Multi-point Channel Charting,” in International Wireless Communications and Mobile Computing (IWCMC). Harbin City, China: IEEE, 2021, pp. 1654-1660.
[36] Q. Zhang and W. Saad, “Semi-Supervised Learning for Channel Charting-Aided IoT Localization in Millimeter Wave Networks,” in IEEE Global Communications Conference (GLOBECOM). Madrid, Spain: IEEE, 2021.
[37] P. Ferrand, A. Decurninge, L. G. Ordoñez, and M. Guillaud, “Triplet-Based Wireless Channel Charting,” in IEEE Global Communications Conference (GLOBECOM). Taipei, Taiwan: IEEE, 2020.
[38] B. Rappaport, E. Gönültaş. J. Hoydis, M. Arnold, P. K. Srinath, and C. Studer, “Improving Channel Charting using a Split Triplet Loss and an Inertial Regularizer,” in 17th International Symposium on Wireless Communication Systems (ISWCS). Berlin, Germany: IEEE, 2021.
[39] F. Ghazvinian Zanjani, I. Karmanov, H. Ackermann, D. Dijkman, S. Merlin, M. Welling, and F. Porikli, “Modality-agnostic topology aware localization,” Advances in Neural Information Processing Systems, vol. 34, pp. 10457-10468, 2021.
[40] T. Ponnada, H. Al-Tous, O. Tirkkonen, and C. Studer, “An Out-of-Sample Extension for Wireless Multipoint Channel Charting,” in International Conference on Cognitive Radio Oriented Wireless Networks. Poznan, Poland; Springer, 2019, pp. 208-217.
[41] C. Geng, H. Huang, and J. Langerman, “Multipoint Channel Charting With Multiple-Input Multiple-Output Convolutional Autoencoder,” in IEEE/ION Position, Location and Navigation Symposium (PLANS). Portland, OR, USA: IEEE, 2020, pp. 1022-1028.
[42] P. Huang, O. Castañeda, E. Gönültaş, S. Medjkouh, O. Tirkkonen, T. Goldstein, and C. Studer, “Improving Channel Charting with Representation-Constrained Autoencoders,” in IEEE 20th International Workshop on Signal Processing Advances in Wireless Communications (SPAWC). Cannes, France: IEEE, 2019.
[43] T. Yassine, L. Le Magoarou, S. Paquelet, and M. Crussière, “Leveraging triplet loss and nonlinear dimensionality reduction for on-the-fly channel charting,” in 2022 IEEE 23rd International Workshop on Signal Processing Advances in Wireless Communication (SPAWC). IEEE, 2022, pp. 1-5.
[44] K. S. Chong and L. Kleeman, “Accurate odometry and error modelling for a mobile robot,” in Proceedings of International Conference on Robotics and Automation, vol. 4. IEEE, 1997, pp. 2783-2788.
[45] D. Scaramuzza and F. Fraundorfer, “Visual odometry [tutorial],” IEEE robotics & automation magazine, vol. 18, no. 4, pp. 80-92, 2011.
[46] X. Hou and J. Bergmann, “Pedestrian dead reckoning with wearable sensors: A systematic review,” IEEE Sensors Journal, vol. 21, no. 1, pp. 143-152, 2020.
[47] J. B. Kruskal, “Multidimensional scaling by optimizing goodness of fit to a nonmetric hypothesis,” Psychometrika, vol. 29, no. 1, pp. 1-27, 1964.
[48] J. W. Sammon, “A nonlinear mapping for data structure analysis,” IEEE Transactions on computers, vol. 100, no. 5, pp. 401-409, 1969.
[49] H. Ismail Fawaz, G. Forestier, J. Weber, L. Idoumghar, and P.-A. Muller, “Deep learning for time series classification: a review,” Dara mining and knowledge discovery, vol. 33, no. 4, pp. 917-963, 2019.
[50] M. Cuturi, “Sinkhorn distances: Lightspeed computation of optimal transport,” Advances in neural information processing systems, vol. 26, 2013.
[51] F. Euchner, M. Gauger, S. Dorner, and S. ten Brink, “A Distributed Massive MIMO Channel Sounder for “Big CSI Data”-driven Machine Learning,” in WSA 2021; 25th International ITC Workshop on Smart Antennas, 2021.

1. A method, comprising:
receiving from at least one device information on a movement of the at least one device, and receiving from at least one device channel state information acquired by the at least one device at a plurality of positions,
determining from the movement information distance information indicating a plurality of distances, wherein each of the plurality of distances indicates a distance between two of the plurality of positions, where the at least one device has acquired the channel state information, and
training an artificial intelligence system using the channel state information acquired at the plurality of positions and using the distance information, so that the artificial intelligence system returns a position value as output of the artificial intelligence system when receiving channel state information as input of the artificial intelligence system.

2. The method according to claim 1,
wherein the artificial intelligence system is trained by inputting the distance information and the channel state information into the artificial intelligence system for the training of the artificial intelligence system, but without inputting the plurality of positions into the artificial intelligence system for the training.

3. The method according to claim 1,
wherein the artificial intelligence system is trained using a plurality of training data tuples,
wherein each training data tuple of the plurality of training data tuples comprises a distance of the plurality of distances between a first position and a second position of the plurality of positions, first channel state information data that has been acquired at the first position, and second channel state information data that has been acquired at the second position.

4. The method according to claim 1,
wherein the artificial intelligence system is trained by minimizing a difference between
a distance of the plurality of distances between a first position and a second position of the plurality of positions, and
a distance between a first position value and a second position value, wherein the first position value is output by the artificial intelligence system, when the artificial intelligent system receives the channel state information acquired at the first position, and wherein the second position value is output by the artificial intelligence system, when the artificial intelligent system receives the channel state information acquired at the second position.

5. The method according to claim 1,
wherein the information on the movement of the at least one device comprises information on an acceleration and/or information on a rotation rate, and/or information on a magnetic field, and/or information on a velocity, and/or information on a number of movement steps, and/or information on (e.g., atmospheric) pressure.

6. The method according to claim 1,
wherein the information on the movement of the at least one device comprises information on a direction of the movement of the at least one device.

7. The method according to claim 1,
wherein the movement of the at least one device represents a movement along a first trajectory and represents a movement along a second trajectory, and the at least one device acquires the channel state information when being on the first trajectory and when being on the second trajectory, and
wherein the at least one device conducts the movement along the first trajectory and along the second trajectory such that the first trajectory and the second trajectory overlap and/or intersect.

8. The method according to claim 1,
wherein the at least one device are two or more devices (e.g., a crowd of devices),
wherein the two or more devices move along different trajectories to determine the channel state information.

9. The method according to claim 1,
wherein determining the distance information is conducted using at least one of the following concepts:
a localization concept which employs time-of-arrival information and/or time-difference-of-arrival information and/or time-of-flight information and/or received signal strength indication (RSSI) information and/or angular information (e.g., angle-of-arrival and/or angle-of-departure information);
a GPS- or UWB- or Bluetooth- or WLAN-based localization concept;
a localization concept based on sidelink ranging.

10. The method according to claim 1,
wherein the method comprises determining a quality measure, e.g., a standard deviation, for an estimation of the plurality of distances being determined from the movement information, where the at least one device has acquired the channel state information,
wherein optimizing the artificial intelligence system is conducted using the quality measure.

11. The method according to claim 1,
wherein artificial intelligence system that is trained is a neural network, e.g., a Siamese neural network.

12. The method according to claim 1, wherein the method further comprises:
optimizing a transformation rule, which transforms a position value, which is output by the artificial intelligence system, the position value being represented in a first coordinate system, from the first coordinate system to a second coordinate system,
wherein optimizing the transformation rule is conducted using information on an area within the second coordinate system that is not accessible for the at least one device and/or an area within the second coordinate system where the at least one device cannot be located and/or using information on location probabilities of that the at least one device.

13. A method, comprising:
training an artificial intelligence system using channel state information acquired at a plurality of positions by at least one device, and using distances between the plurality of positions, so that the artificial intelligence system returns a position value as output of the artificial intelligence system when receiving channel state information as input of the artificial intelligence system, and
optimizing a transformation rule, which transforms a position value, which is output by the artificial intelligence system, the position value being represented in a first coordinate system, from the first coordinate system to a second coordinate system,
wherein optimizing the transformation rule is conducted using information on an area within the second coordinate system that is not accessible for the at least one device and/or using information on an area within the second coordinate system where the at least one device cannot be located, and/or using information on location probabilities of that the at least one device.

14. The method according to claim 13,
wherein the information on the area within the second coordinate system that is not accessible for the at least one device and/or the information on the area within the second coordinate system where the at least one device cannot be located, is acquired from a map.

15. The method according to claim 13,
wherein the second coordinate system is a coordinate system of a map.

16. The method according to claim 13,
wherein the transformation rule which transforms the position value being output by the artificial intelligence system from the first coordinate system to the coordinate system of the map, comprises at least one rotation step and/or at least one translation step, and/or at least one scaling step (e.g., stretching and/or compressing).

17. The method according to claim 13,
wherein optimizing the transformation rule is conducted
taking into account for optimizing if the transformation rule transforms one or more position values acquired from training data from the first coordinate system to coordinate values of the second coordinate system at locations where a map indicates that the at least one device cannot be located, and/or
taking into account for optimizing if the transformation rule transforms one or more position values acquired from training data from the first coordinate system to coordinate values of the second coordinate system at locations where the map indicates that it is possible that the at least one device may possibly be located.

18. The method according to claim 13,
wherein the method comprises employing one or more reference coordinates for optimizing the transformation rule.

19. An apparatus comprising an artificial intelligence system,
wherein the artificial intelligence system has been trained with training data by conducting:
to generate the training data, receiving, from at least one device, information on a movement of the at least one device, and receiving from at least one device channel state information acquired by the at least one device at a plurality of positions,
to generate the training data, determining from the movement information distance information indicating a plurality of distances, wherein each of the plurality of distances indicates a distance between two of the plurality of positions, where the at least one device has acquired the channel state information, and
training the artificial intelligence system with the training data by using the channel state information acquired at the plurality of positions and by using the distance information, so that the artificial intelligence system returns a position value as output of the artificial intelligence system when receiving channel state information as input of the artificial intelligence system.

20. The apparatus according to claim 19,
wherein the artificial intelligence system has been trained by inputting the distance information and the channel state information into the artificial intelligence system for the training of the artificial intelligence system, but without inputting the plurality of positions into the artificial intelligence system for the training.

21. The apparatus according to claim 19,
wherein the artificial intelligence system has been trained using the training data comprising a plurality of training data tuples,
wherein each training data tuple of the plurality of training data tuples comprises a distance of the plurality of distances between a first position and a second position of the plurality of positions, first channel state information data that has been acquired at the first position, and second channel state information data that has been acquired at the second position.

22. The apparatus according to claim 19,
wherein the artificial intelligence system has been trained by minimizing a difference between
a distance of the plurality of distances between a first position and a second position of the plurality of positions, and
a distance between a first position value and a second position value, wherein the first position value is output by the artificial intelligence system, when the artificial intelligent system receives the channel state information acquired at the first position, and wherein the second position value is output by the artificial intelligence system, when the artificial intelligent system receives the channel state information acquired at the second position.

23. The apparatus according to claim 19,
wherein the information on the movement of the at least one device comprises information on an acceleration and/or information on a rotation rate, and/or information on a magnetic field, and/or information on a velocity, and/or information on a number of movement steps, and/or information on (e.g., atmospheric) pressure.

24. The apparatus according to claim 19,
wherein the information on the movement of the at least one device comprises information on a direction of the movement of the at least one device.

25. The apparatus according to claim 19,
wherein the movement of the at least one device represents a movement along a first trajectory and represents a movement along a second trajectory, and the at least one device acquires the channel state information when being on the first trajectory and when being on the second trajectory, and
wherein, to generate the training data, the at least one device has conducted the movement along the first trajectory and along the second trajectory such that the first trajectory and the second trajectory overlap and/or intersect.

26. The apparatus according to claim 19,
wherein the at least one device are two or more devices (e.g., a crowd of devices),
wherein the two or more devices have moved along different trajectories to determine the channel state information.

27. The apparatus according to claim 19,
wherein, to generate the training data, the distance information has been determined using at least one of the following concepts:
a localization concept which employs time-of-arrival information and/or time-difference-of-arrival information and/or time-of-flight information and/or received signal strength indication (RSSI) information and/or angular information (e.g., angle-of-arrival and/or angle-of-departure information);
a GPS- or UWB- or Bluetooth- or WLAN-based localization concept;
a localization concept based on sidelink ranging.

28. The apparatus according to claim 19,
wherein, to generate the training data, a quality measure, e.g., a standard deviation, for an estimation of the plurality of distances being determined from the movement information, where the at least one device has acquired the channel state information, has been determined,
wherein optimizing the artificial intelligence system has been conducted using the quality measure.

29. The apparatus according to claim 19,
wherein artificial intelligence system is a neural network, e.g., a Siamese neural network.

30. The apparatus according to claim 19,
wherein the apparatus further comprises a transform unit implementing a transformation rule for transforming a position value, which is output by the artificial intelligence system, the position value being represented in a first coordinate system, from the first coordinate system to a second coordinate system,
wherein the transformation rule has been optimized using information on an area within the second coordinate system that is not accessible for the at least one device and/or an area within the second coordinate system where the at least one device cannot be located and/or using information on location probabilities of that the at least one device.

31. An apparatus comprising an artificial intelligence system,
wherein the artificial intelligence system has been trained using channel state information acquired at a plurality of positions by at least one device, and using distances between the plurality of positions, so that the artificial intelligence system returns a position value as output of the artificial intelligence system when receiving channel state information as input of the artificial intelligence system, and
wherein the apparatus further comprises a transform unit implementing a transformation rule for transforming a position value, which is output by the artificial intelligence system, the position value being represented in a first coordinate system, from the first coordinate system to a second coordinate system,
wherein the transformation rule has been optimized using information on an area within the second coordinate system that is not accessible for the at least one device and/or an area within the second coordinate system where the at least one device cannot be located and/or using information on location probabilities of that the at least one device.

32. The apparatus according to claim 31,
wherein the information on the area within the second coordinate system that is not accessible for the at least one device and/or the information on the area within the second coordinate system where the at least one device cannot be located, has been acquired from a map.

33. The apparatus according to claim 31,
wherein the second coordinate system is a coordinate system of a map.

34. The apparatus according to claim 31,
wherein the transformation rule which transforms the position value being output by the artificial intelligence system from the first coordinate system to the coordinate system of the map, comprises at least one rotation step, and/or at least one translation step, and/or at least one scaling step (e.g., stretching and/or compressing).

35. The apparatus according to claim 31,
wherein optimizing the transformation rule has been conducted
taking into account for optimizing if the transformation rule transforms one or more position values acquired from training data from the first coordinate system to coordinate values of the second coordinate system at locations where a map indicates that the at least one device cannot be located, and/or
taking into account for optimizing if the transformation rule transforms one or more position values acquired from training data from the first coordinate system to coordinate values of the second coordinate system at locations where the map indicates that it is possible that the at least one device may possibly be located.

36. The apparatus according to claim 31,
wherein the transformation rule has been optimized by employing one or more reference coordinates.

37. A method for employing an apparatus comprising an artificial intelligence system, wherein the method comprises:
providing channel state information as input of the artificial intelligence system, and
receiving a position value as input of the artificial intelligence system,
wherein the artificial intelligence system has been trained with training data by conducting:
to generate the training data, receiving, from at least one device, information on a movement of the at least one device, and receiving from at least one device channel state information acquired by the at least one device at a plurality of positions,
to generate the training data, determining from the movement information distance information indicating a plurality of distances, wherein each of the plurality of distances indicates a distance between two of the plurality of positions, where the at least one device has acquired the channel state information, and
training the artificial intelligence system with the training data by using the channel state information acquired at the plurality of positions and by using the distance information, so that the artificial intelligence system returns a position value as output of the artificial intelligence system when receiving channel state information as input of the artificial intelligence system.

38. A method for employing an apparatus comprising an artificial intelligence system and a transform unit, wherein the method comprises:
providing channel state information as input of the artificial intelligence system,
receiving a position value as input of the artificial intelligence system, and
transforming, by the transform unit, the position value, which is represented in a first coordinate system, from the first coordinate system to a second coordinate system, using a transformation rule,
wherein the artificial intelligence system has been trained using channel state information acquired at a plurality of positions by at least one device, and using distances between the plurality of positions, so that the artificial intelligence system returns a position value as output of the artificial intelligence system when receiving channel state information as input of the artificial intelligence system, and
wherein the transformation rule is a rule for transforming a position value, which is output by the artificial intelligence system, the position value being represented in the first coordinate system, from the first coordinate system to the second coordinate system,
wherein the transformation rule has been optimized using information on an area within the second coordinate system that is not accessible for the at least one device and/or an area within the second coordinate system where the at least one device cannot be located and/or using information on location probabilities of that the at least one device.

39. A non-transitory digital storage medium having a computer program stored thereon to perform the method of claim 1 when said computer program is run by a computer.

40. A non-transitory digital storage medium having a computer program stored thereon to perform the method of claim 13 when said computer program is run by a computer.

41. A non-transitory digital storage medium having a computer program stored thereon to perform the method of claim 37 when said computer program is run by a computer.

42. A non-transitory digital storage medium having a computer program stored thereon to perform the method of claim 38 when said computer program is run by a computer.
